(19) United States
(12) Patent Application Publication
(10) Pub. No.: US 2026/0176847 A1
(43) Pub. Date: Jun. 25, 2026

(54) WORK MACHINE AND CONTROL APPARATUS FOR WORK MACHINE

(71) Applicant: SUMITOMO HEAVY INDUSTRIES, LTD., Tokyo (JP)

(72) Inventors: Jun NISHIMAKI, Kanagawa (JP); Kazunori HIRANUMA, Kanagawa (JP)

(21) Appl. No.: 19/416,419

(22) Filed: Dec. 11, 2025

(30) Foreign Application Priority Data
Dec. 20, 2024 (JP) 2024-225496

(51) Int. Cl. E02F 9/26; G01G 19/10; E02F 3/32

(52) U.S. Cl. CPC E02F 9/265; G01G 19/10; E02F 3/32

(57) ABSTRACT

A work machine includes: a work machine body; an attachment attached to the work machine body; a work tool provided at a distal end of the attachment; and control circuitry. The control circuitry is configured to, when a determination is made that a piston of a cylinder that operates the attachment has reached a predetermined range based on detection information related to a raising operation of the attachment after an object is held in the work tool, cause an obtaining measurement result of a weight of the object to differ according to a state of the work machine at a time when the determination is made.

### RELATED APPLICATION

The present application is based on and claims priority to Japanese Patent Application No. 2024-225496 filed on December 20, 2024, the entire contents of which are hereby incorporated by reference.

### BACKGROUND

### 1. Field of the Invention

The present disclosure relates to a work machine and a control apparatus for the work machine.

### 2. Description of the Related Art

When measuring the weight of an object such as earth and sand loaded from a shovel to a bed of a dump truck or the like, there has been known a technique for suppressing the fluctuation of a weight measurement result due to disturbance. Specifically, for example, there has been known a technique for compensating the torque for rotating a boom based on at least one of the centrifugal force of an arm or the inertial force of an arm and measuring the weight of a conveyed object conveyed by an attachment based on the compensated torque.

### SUMMARY

A work machine according to an embodiment of the present disclosure is a work machine including: a work machine body; an attachment attached to the work machine body; a work tool provided at a distal end of the attachment; and control circuitry configured to, when a determination is made that a piston of a cylinder that operates the attachment has reached a predetermined range based on detection information related to a raising operation of the attachment after an object is held in the work tool, cause an obtaining measurement result of a weight of the object to differ according to a state of the work machine at a time when the determination is made.

The work machine according to the embodiment of the present disclosure is a work machine including: a work machine body; an attachment attached to the work machine body; and a work tool provided at a distal end of the attachment, wherein the work machine includes control circuitry configured to, when a determination is made that a piston of a cylinder that operates the attachment has reached a predetermined range based on detection information related to a raising operation of the attachment after an object is held in the work tool, cause an obtaining measurement result of a weight of the object to differ according to a state of the work machine at a time when the determination is made, wherein the control circuitry obtains the weight of the object calculated based on the detection information related to the raising operation of the attachment as the measurement result at the time the determination is made, when the state of the work machine at the time the determination is made is a state after the raising operation of the attachment has started and the measurement result of the weight of the object has not been obtained, and wherein when the state of the work machine at the time the determination is made is a state after the raising operation of the attachment has started and the measurement result of the weight of the object has been obtained, the control circuitry obtains the measurement result that has been obtained as the measurement result of the weight of the object at the time the determination is made, and when the state of the work machine at the time the determination is made is a state at the start of the raising operation of the attachment, the control circuitry does not obtain the measurement result.

The control apparatus for a work machine according to the embodiment of the present disclosure is a control apparatus for a work machine including: a work machine body; an attachment attached to the work machine body; and a work tool provided at the distal end of the attachment, wherein the control apparatus includes control circuitry configured to, when a determination is made that a piston of a cylinder that operates the attachment has reached a predetermined range based on detection information related to a raising operation of the attachment after an object is held in the work tool, cause an obtaining measurement result of a weight of the object to differ according to a state of the work machine at a time when the determination is made.

### BRIEF DESCRIPTION OF THE DRAWINGS

FIG. 1 is a side view of a shovel as an excavator according to the present embodiment;

FIG. 2 is a schematic diagram illustrating an example of a configuration of a drive system of the shovel according to the present embodiment;

FIG. 3 is a schematic diagram illustrating an example of a configuration of a hydraulic system of the shovel according to the present embodiment;

FIG. 4A is a schematic diagram illustrating an example of components relating to an operation system of the hydraulic system of the shovel according to the present embodiment;

FIG. 4B is another schematic diagram illustrating an example of components relating to the operation system of the hydraulic system of the shovel according to the present embodiment;

FIG. 4C is still another schematic diagram illustrating an example of components relating to an operation system of the hydraulic system of the shovel according to the present embodiment;

FIG. 5 is a diagram illustrating an example of a configuration of an electric operation system of the shovel according to the present embodiment;

FIG. 6 is a schematic diagram illustrating an example of components relating to an earth-and-sand load detection function of the shovel according to the present embodiment;

FIG. 7 is a diagram illustrating an excavation and loading operation of the shovel; and

FIG. 8 is a flowchart illustrating an example of load weight determination processing.

### DETAILED DESCRIPTION

In the existing technique described above, the centrifugal force of the arm and the inertial force of the arm are regarded as disturbances which cause the measurement result of the weight of an object to vary. However, there are other disturbances which cause the measurement result of the weight of an object to vary.

The disclosed technique has been developed in view of the above circumstances, and an object thereof is to enhance the measurement accuracy of the weight of an object.

Hereinafter, embodiments of the present disclosure will be described with reference to the drawings. Furthermore, the embodiments described in the following are not intended to limit the invention but are exemplary, and not all features or combinations thereof described in the embodiments are necessarily essential to the invention. In each of the drawings, the same or corresponding components are denoted by the same or corresponding reference numerals, and description thereof may be omitted.

### [Outline of shovel]

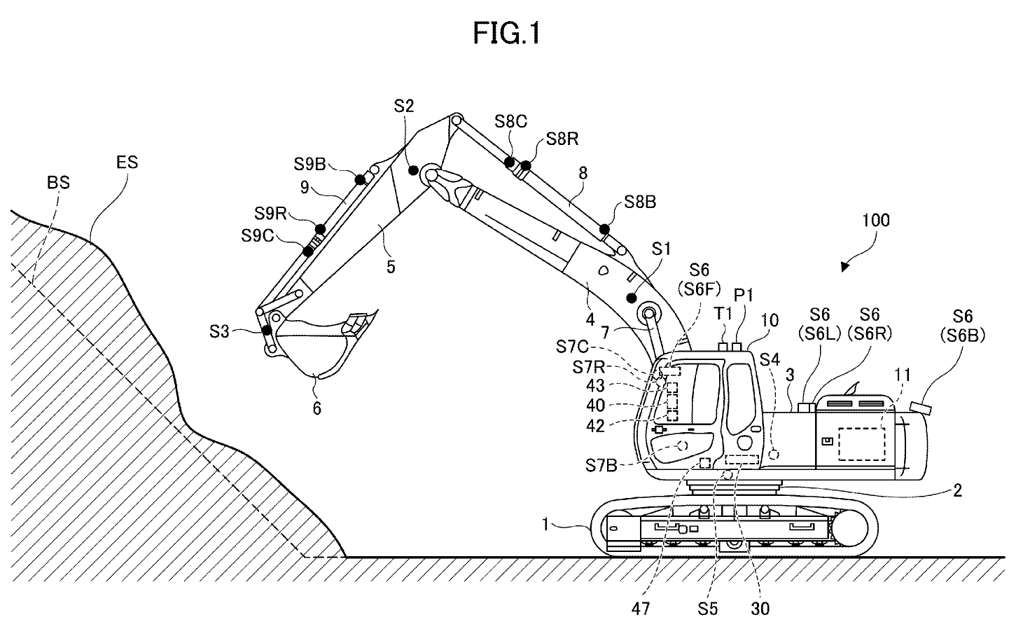

First, an outline of a shovel (work machine) 100 according to the present embodiment will be described with reference to FIG. 1. FIG. 1 is a side view of a shovel as an excavator according to the present embodiment.

In FIG. 1, the shovel 100 is positioned on a horizontal plane facing an upward slope ES to be constructed, and an upward cut slope BS (i.e., the post-construction daylight shape for the upward slope ES), which is an example of a target construction surface to be described in the following, is also described. The upward slope ES to be constructed is provided with a cylindrical body (not illustrated) indicating the direction normal to the upward cut slope BS, which is a target construction surface.

The shovel 100 according to the present embodiment is provided with a lower traveling body 1, an upper swivel body 3 mounted on the lower traveling body 1 to freely turn via a turner 2, a boom 4, an arm 5, and a bucket 6 included in an attachment (work machine), and a cab 10. The lower traveling body 1 and the upper swivel body 3 are included in a work machine body.

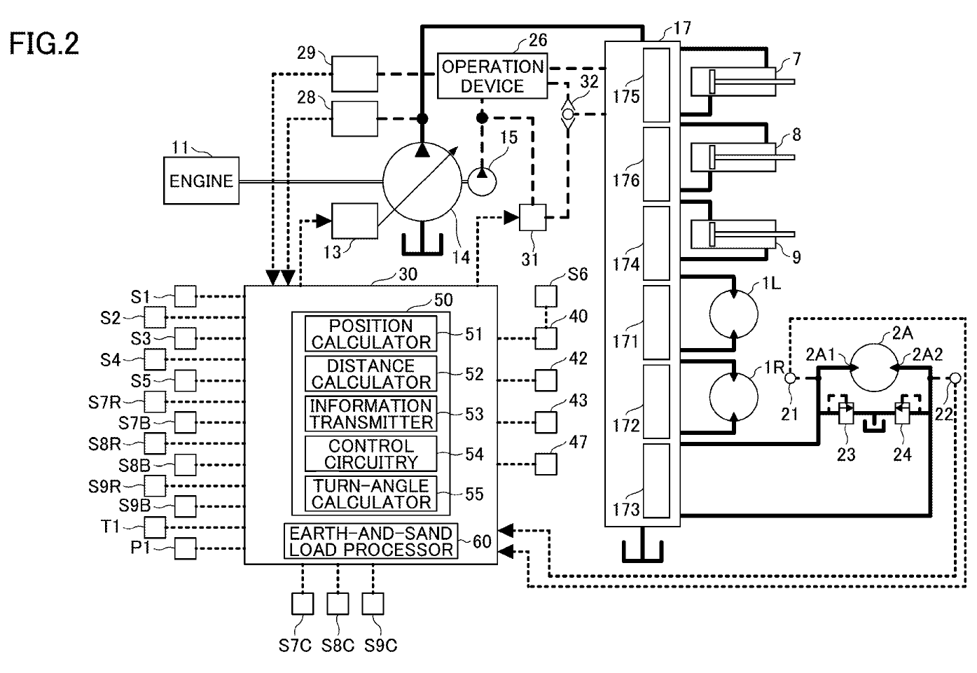

The lower traveling body 1 drives the shovel 100 by a pair of left and right crawlers being hydraulically driven by traveling hydraulic motors 1L and 1R (see FIG. 2, described in the following), respectively. That is, the pair of traveling hydraulic motors 1L and 1R (an example of traveling motors) drives the lower traveling body 1 (crawler) as a driven part.

The upper swivel body 3 rotates with respect to the lower traveling body 1 by being driven by a swivel hydraulic motor 2A (see FIG. 2, described in the following). That is, the swivel hydraulic motor 2A is a swivel driving section for driving the upper swivel body 3 as a driven part, and the direction of the upper swivel body 3 can be changed.

The upper swivel body 3 may be electrically driven by an electric motor (hereinafter referred to as "swivel motor") instead of the swivel hydraulic motor 2A. That is, like the swivel hydraulic motor 2A, the swivel motor is a swivel driving section for driving the upper swivel body 3 as a driven section, and the direction of the upper swivel body 3 can be changed.

The boom 4 is rotatably attached to the center of the front part of the upper swivel body 3 in a tiltable manner, the arm 5 is attached to the tip of the boom 4 in a vertically rotatable manner, and the bucket 6 as an end attachment is attached to the tip of the arm 5 in a vertically rotatable manner. The boom 4, the arm 5, and the bucket 6 are respectively hydraulically driven by a boom cylinder 7, an arm cylinder 8, and a bucket cylinder 9 as hydraulic actuators.

Note that the bucket 6 is an example of the end attachment, and other end attachments, such as a slope bucket, a dredging bucket, a breaker, a lifting magnet, a grapple, a fork, a harvester including a chainsaw, or the like, may be attached to the tip of the arm 5 in place of the bucket 6 according to the work contents or the like.

The cab 10 is a driver's cab in which an operator rides, and is provided on the front left side of the upper swivel body 3.

### [Configuration of shovel]

Next, a specific configuration of the shovel 100 according to the present embodiment will be described with reference to FIG. 2 in addition to FIG. 1. FIG. 2 is a schematic diagram illustrating an example of a configuration of a drive system of the shovel according to the present embodiment. In FIG. 2, a mechanical power system, a hydraulic oil line, a pilot line, and an electric control system are indicated by double lines, solid lines, broken lines, and dotted lines, respectively.

The drive system of the shovel 100 according to the present embodiment includes an engine 11, a regulator 13, a main pump 14, and a control valve 17. The hydraulic drive system of the shovel 100 according to the present embodiment includes hydraulic actuators such as the traveling hydraulic motors 1L and 1R, the swivel hydraulic motor 2A, the boom cylinder 7, the arm cylinder 8, and the bucket cylinder 9 for hydraulically driving the lower traveling body 1, the upper swivel body 3, the boom 4, the arm 5, and the bucket 6, respectively, as described above.

The engine 11 is a main power source in the hydraulic drive system, and is mounted, for example, at the rear of the upper swivel body 3. Specifically, the engine 11 rotates at a predetermined target rotational speed under direct or indirect control by a controller 30 described in the following, and drives the main pump 14 and a pilot pump 15. The engine 11 is, for example, a diesel engine that uses diesel as fuel.

The regulator 13 controls the discharge amount of the main pump 14. For example, the regulator 13 adjusts an angle (inclination angle) of a swash plate of the main pump 14 in accordance with a control command from the controller 30. The regulator 13 includes, for example, regulators 13L and 13R as will be described in the following.

The main pump 14 is mounted, for example, at the rear of the upper swivel body 3 in the same manner as the engine 11, and supplies hydraulic oil to the control valve 17 through a high-pressure hydraulic line. The main pump 14 is driven by the engine 11 as described above. The main pump 14 is, for example, a variable displacement hydraulic pump, and as described above, under the control of the controller 30, the inclination angle of the swash plate is adjusted by the regulator 13, whereby the stroke length of a piston is adjusted and a discharge flow rate (discharge pressure) is controlled. The main pump 14 includes, for example, main pumps 14L and 14R, as described in the following.

The control valve 17 is, for example, a hydraulic control apparatus which is mounted at the center of the upper swivel body 3 and controls the hydraulic drive system in response to the operation of an operation device 26 by an operator. The control valve 17 is connected to the main pump 14 via the high-pressure hydraulic line, as described above, and selectively supplies the hydraulic oil supplied from the main pump 14 to the hydraulic actuators (the traveling hydraulic motors 1L and 1R, the swivel hydraulic motor 2A, the boom cylinder 7, the arm cylinder 8, and the bucket cylinder 9) in response to an operation state of the operation device 26. Specifically, the control valve 17 includes control valves 171 to 176 which control the flow rate and the flow direction of the hydraulic oil supplied from the main pump 14 to each of the hydraulic actuators. More specifically, the control valve 171 corresponds to the traveling hydraulic motor 1L, the control valve 172 corresponds to the traveling hydraulic motor 1R, and the control valve 173 corresponds to the swivel hydraulic motor 2A. The control valve 174 corresponds to the bucket cylinder 9, the control valve 175 corresponds to the boom cylinder 7, and the control valve 176 corresponds to the arm cylinder 8. The control valve 175 includes, for example, control valves 175L and 175R as described in the following, and the control valve 176 includes, for example, control valves 176L and 176R as described in the following. Details of the control valve 171 to 176 will be described in the following.

An operation system of the shovel 100 according to the present embodiment includes the pilot pump 15 and the operation device 26. The operation system of the shovel 100 includes a shuttle valve 32 as a configuration related to a machine control function by the controller 30 described in the following.

The pilot pump 15 is mounted, for example, at the rear of the upper swivel body 3, and supplies pilot pressure to the operation device 26 via the pilot line. The pilot pump 15 is, for example, a fixed displacement hydraulic pump, and is driven by the engine 11 as described above.

The operation device (an example of an operation part) 26 is provided near the operator's seat of the cab 10. The operation device 26 is an operation input means for an operator to operate various operation elements (the lower traveling body 1, the upper swivel body 3, the boom 4, the arm 5, the bucket 6, etc.). In other words, the operation device 26 is an operation input means for an operator to operate hydraulic actuators (that is, the traveling hydraulic motors 1L and 1R, the swivel hydraulic motor 2A, the boom cylinder 7, the arm cylinder 8, the bucket cylinder 9, and the like) for driving respective operation elements.

The operation device 26 is connected to the control valve 17 directly through the pilot line on a secondary side or indirectly through the shuttle valve 32 provided in the pilot line on the secondary side. Thus, a pilot pressure corresponding to the operation state of the lower traveling body 1, the upper swivel body 3, the boom 4, the arm 5, the bucket 6, and the like in the operation device 26 can be input to the control valve 17. Therefore, the control valve 17 can drive the respective hydraulic actuators according to the operation state in the operation device 26.

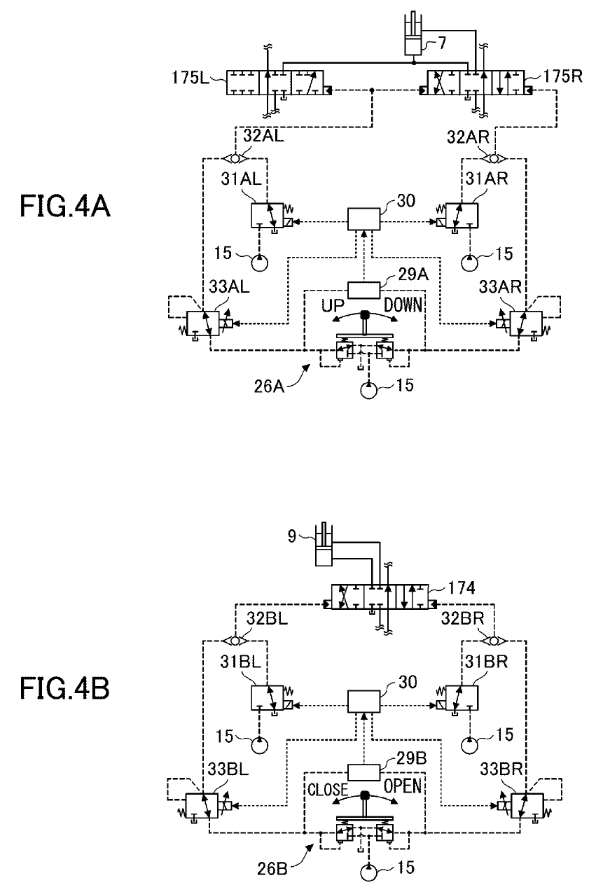

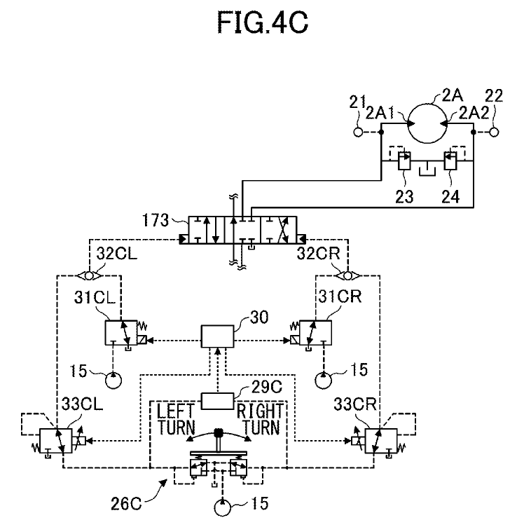

The operation device 26 includes, for example, a lever device for operating the arm 5 (arm cylinder 8). The operation device 26 also includes, for example, lever devices 26A to 26C for operating the boom 4 (boom cylinder 7), the bucket 6 (bucket cylinder 9) and the upper swivel body 3 (swivel hydraulic motor 2A), respectively (see FIG. 4). The operation device 26 also includes, for example, a lever device and a pedal device for operating the pair of left and right crawlers (traveling hydraulic motors 1L and 1R) of the lower traveling body 1, respectively.

The shuttle valve 32 includes two inlet ports and one outlet port. The shuttle valve 32 outputs hydraulic oil having a pilot pressure higher than the pilot pressure input to the two inlet ports to the outlet port. One of the two inlet ports of the shuttle valve 32 is connected to the operation device 26, and the other is connected to a proportional valve 31. An outlet port of the shuttle valve 32 is connected to a pilot port of a corresponding control valve in the control valve 17 through the pilot line (See FIG. 4 for details.). Therefore, the shuttle valve 32 can cause the pilot pressure higher than the pilot pressure generated by the operation device 26 or the pilot pressure generated by the proportional valve 31 to act on the pilot port of the corresponding control valve. That is, by causing the proportional valve 31 to output a pilot pressure higher than a secondary-side pilot pressure output from the operation device 26, the controller 30 described in the following can control the corresponding control valve and control the operation of various operating elements without depending on the operation of the operation device 26 by an operator. The shuttle valve 32 includes, for example, shuttle valves 32AL, 32AR, 32BL, 32BR, 32CL, and 32CR as described in the following.

The control system of the shovel 100 according to the present embodiment includes the controller 30, a discharge pressure sensor 28, an operation pressure sensor 29, the proportional valve 31, a display device 40, an input device 42, an audio output device 43, a storage device 47, a boom angle sensor S1, an arm angle sensor S2, a bucket angle sensor S3, a machine-machine-body inclination sensor S4, a turning state sensor S5, an imaging device S6, a positioning device P1, and a communicator T1.

The controller 30 (an example of a control apparatus) is provided in the cab 10, for example, and controls the drive of the shovel 100. The controller 30 may be achieved by any hardware, software, or combination thereof. For example, the controller 30 mainly includes a central processing unit (CPU), a read only memory (ROM), a random access memory (RAM), a nonvolatile auxiliary storage device, and a microcomputer including various input/output interfaces and the like. The controller 30 implements various functions by executing, for example, various programs stored in the ROM and the nonvolatile auxiliary storage device on the CPU.

For example, the controller 30 sets a target rotational speed based on a work mode or the like set in advance by a predetermined operation performed by an operator or the like, and performs drive control to rotate the engine 11 at a constant speed. Furthermore, for example, the controller 30 outputs a control command to the regulator 13 as necessary to change a discharge amount of the main pump 14.

Furthermore, for example, the controller 30 performs control related to a machine guidance function for guiding manual operation of the shovel 100 by an operator through the operation device 26. Furthermore, for example, the controller 30 performs control related to the machine control function for automatically supporting the manual operation of the shovel 100 by an operator through the operation device 26. That is, the controller 30 includes a machine guidance section 50 as a functional section related to a machine guidance function and the machine control function. The controller 30 includes an earth-and-sand load processor 60.

The earth-and-sand load processor 60 of the present embodiment determines whether or not the piston of the boom cylinder 7 has reached a predetermined range in an excavation and loading operation described in the following. The predetermined range is a range (cushion area) where a cushion function activates.

When it is determined that the piston of the boom cylinder 7 has reached the predetermined range, the earth-and-sand load processor 60 causes a measurement result of the obtained earth-and-sand weight to differ according to the state of the shovel 100 at the time when the determination is made.

Here, the cushion function will be described. The cushion function is a function for reducing the speed of the piston of a hydraulic cylinder when the piston approaches the stroke end. Due to the action of the cushion function, the impact of the piston of the hydraulic cylinder when it reaches the stroke end is mitigated. Specifically, when the boom cylinder 7 is extended (boom-up operation) and the piston of the boom cylinder 7 reaches the cushion area, the pressure of a rod-side oil chamber (boom rod pressure) of the boom cylinder 7 increases, and the speed of the piston decreases. At this time, the earth and sand weight cannot be accurately calculated due to the influence of the increase in the boom rod pressure.

The cushion function is achieved by, for example, a method of reducing the flow rate of the hydraulic oil by controlling a control valve or a method of configuring a hydraulic cylinder such that the flow rate of the hydraulic oil decreases when the piston reaches the cushion area.

In the present embodiment, when it is determined that the piston of the boom cylinder 7 has reached the predetermined range, a value to be adopted as a measurement result is caused to differ according to the state of the shovel 100 at that time.

Therefore, according to the present embodiment, the earth and sand weight calculated in a state where the influence of the piston of the boom cylinder 7 having reached the predetermined range is suppressed can be obtained as a measurement result. Furthermore, according to the present embodiment, when the earth and sand weight calculated during the period from the start of the raising operation of the boom 4 until the piston of the boom cylinder 7 has reached a predetermined range is determined as a measurement result, this earth and sand weight is obtained as a measurement result. Therefore, according to the present embodiment, a region where the earth and sand weight can be measured with high accuracy can be maximized. Details of the earth-and-sand load processor 60 will be described in the following.

Note that a part of the functions of the controller 30 may be achieved by another controller (control apparatus). That is, the functions of the controller 30 may be achieved by a plurality of controllers in a distributed manner. For example, the machine guidance function and the machine control function may be achieved by a dedicated controller (control apparatus).

The discharge pressure sensor 28 detects the discharge pressure of the main pump 14. A detection signal corresponding to the discharge pressure detected by the discharge pressure sensor 28 is taken into the controller 30. The discharge pressure sensor 28 includes, for example, discharge pressure sensors 28L and 28R as described in the following.

As described above, the operation pressure sensor 29 detects the pilot pressure on the secondary side of the operation device 26, that is, the pilot pressure corresponding to the operation state (for example, operation contents such as operation direction and operation amount) of each operating element (that is, the hydraulic actuator) in the operation device 26. Detection signals of the pilot pressures corresponding to the operation states of the lower traveling body 1, the upper swivel body 3, the boom 4, the arm 5, the bucket 6 and the like in the operation device 26 by the operation pressure sensor 29 are taken into the controller 30. The operation pressure sensor 29 includes, for example, operation pressure sensors 29A to 29C as described in the following.

In place of the operation pressure sensor 29, another sensor capable of detecting the operation state of each operating element in the operation device 26, for example, an encoder or a potentiometer capable of detecting the operation amount (inclination amount) or the inclination direction of the lever devices 26A to 26C and the like, may be provided.

The proportional valve 31 is provided in the pilot line connecting the pilot pump 15 and the shuttle valve 32, and is configured to change a flow path area (cross-sectional area through which the hydraulic oil can flow) of the pilot line. The proportional valve 31 operates in response to a control command input from the controller 30. Thus, even when the operation device 26 (specifically, the lever devices 26A to 26C) is not operated by an operator, the controller 30 can supply the hydraulic oil discharged from the pilot pump 15 to the pilot port of the corresponding control valve in the control valve 17 via the proportional valve 31 and the shuttle valve 32. The proportional valve 31 includes, for example, proportional valves 31AL, 31AR, 31BL, 31BR, 31CL, and 31CR as described in the following.

The display device 40 is provided in the cab 10 at a place readily visible from a seated operator, and displays various information images under the control of the controller 30. The display device 40 may be connected to the controller 30 via an on-board communication network such as a controller area network (CAN), or may be connected to the controller 30 via a one-to-one dedicated line.

The input device 42 is provided within reach of the seated operator in the cab 10, receives various operation inputs from the operator, and outputs a signal corresponding to the operation inputs to the controller 30. The input device 42 includes a touch panel mounted on a display of the display device for displaying various information images, a knob switch provided at the tip of a lever portion of the lever devices 26A to 26C, a button switch provided around the display device 40, a lever, a toggle, a rotary dial, and the like. The signal corresponding to the contents of an operation performed on the input device 42 is taken into the controller 30.

The audio output device 43 is provided, for example, in the cab 10, connected to the controller 30, and outputs audio under the control of the controller 30. The audio output device 43 is, for example, a speaker or a buzzer. The audio output device 43 audibly outputs various types of information in response to an audio output command from the controller 30.

The storage device 47 is provided in the cab 10, for example, and stores various types of information under the control of the controller 30. The storage device 47 is, for example, a nonvolatile storage medium such as a semiconductor memory. The storage device 47 may store information output from various apparatuses during the operation of the shovel 100, or may store information obtained via various apparatuses before the operation of the shovel 100 is started. The storage device 47 may store, for example, data relating to a target construction surface obtained via the communicator T1 or the like or set via the input device 42 or the like. The target construction surface may be set (stored) by the operator of the shovel 100, or may be set by a construction manager or the like.

The boom angle sensor S1 is attached to the boom 4, and detects an inclination angle (hereinafter referred to as "boom angle") of the boom 4 with respect to the upper swivel body 3, for example, an angle formed by a straight line connecting fulcrums at both ends of the boom 4 with respect to a turning plane of the upper swivel body 3 in a side view. The boom angle sensor S1 may include, for example, a rotary encoder, an acceleration sensor, a 6-axis sensor, an inertial measurement unit (IMU) or the like. The boom angle sensor S1 may include a potentiometer that uses a variable resistor, a cylinder sensor for detecting the stroke amount of a hydraulic cylinder (boom cylinder 7) corresponding to the boom angle, and the like. The same applies to the arm angle sensor S2 and the bucket angle sensor S3. A detection signal corresponding to the boom angle detected by the boom angle sensor S1 is taken into the controller 30.

The arm angle sensor S2 is attached to the arm 5 and detects a turn angle (hereinafter referred to as "arm angle") of the arm 5 with respect to the boom 4, for example, an angle formed by a straight line connecting the fulcrums at both ends of the arm 5 with respect to a straight line connecting the fulcrums at both ends of the boom 4 in a side view. A detection signal corresponding to the arm angle detected by the arm angle sensor S2 is taken into the controller 30.

The bucket angle sensor S3 is attached to the bucket 6 and detects a turn angle (hereinafter referred to as "bucket angle") of the bucket 6 with respect to the arm 5, for example, an angle formed by a straight line connecting the fulcrum and the tip (claw tip) of the bucket 6 with respect to a straight line connecting the fulcrums at both ends of the arm 5 in a side view. A detection signal corresponding to the bucket angle detected by the bucket angle sensor S3 is taken into the controller 30.

The machine-machine-body inclination sensor S4 detects an inclination state of the machine body (the upper swivel body 3 or the lower traveling body 1) with respect to the horizontal plane. The machine-machine-body inclination sensor S4 is attached to the upper swivel body 3, for example, and detects the inclination angles (hereinafter referred to as "front-rear inclination angle" and "left-right inclination angle") of the shovel 100 (that is, the upper swivel body 3) around two axes in the front-rear and left-right directions. The machine-machine-body inclination sensor S4 may include, for example, a rotary encoder, an acceleration sensor, a 6-axis sensor, an IMU, or the like. Detection signals corresponding to the inclination angles (the front-rear and left-right inclination angles) detected by the machine-machine-body inclination sensor S4 are taken into the controller 30.

The turning state sensor S5 outputs detection information related to the turning state of the upper swivel body 3. The turning state sensor S5 detects, for example, a turning angular velocity and the turn angle of the upper swivel body 3. The turning state sensor S5 may include, for example, a gyro sensor, a resolver, a rotary encoder, or the like. Detection signals corresponding to the turn angle and the turning angular velocity of the upper swivel body 3 detected by the turning state sensor S5 are taken into the controller 30. The boom angle sensor S1, the arm angle sensor S2, the bucket angle sensor S3, the machine-body inclination sensor S4, and the turning state sensor S5 are included in attitude sensors. The attitude sensors detect not only a claw tip position of the bucket 6 but also the boom angle, a boom angular velocity, a boom angular acceleration, etc.

The imaging device S6 as a space recognition device captures images of the periphery of the shovel 100. The imaging device S6 includes a front camera S6F configured to image the front of the shovel 100, a left camera S6L configured to image the left side of the shovel 100, a right camera S6R configured to image the right side of the shovel 100, and a rear camera S6B configured to image the rear of the shovel 100.

The front camera S6F is mounted, for example, on the ceiling of the cab 10, that is, inside the cab 10. The front camera S6F may also be mounted outside the cab 10, such as on the roof of the cab 10 or on a side surface of the boom 4. The left camera S6L is mounted on the left end of the upper surface of the upper swivel body 3, the right camera S6R is mounted on the right end of the upper surface of the upper swivel body 3, and the rear camera S6B is mounted on the rear end of the upper surface of the upper swivel body 3.

The imaging device S6 (cameras S6F, S6B, S6L, and S6R) is, for example, a monocular wide-angle camera having a very wide field angle. The imaging device S6 may be a stereo camera, a range image camera, or the like. The image captured by the imaging device S6 is taken into the controller 30 via the display device 40.

The imaging device S6 as the space recognition device may function as an object detection device. In this case, the imaging device S6 may detect an object existing around the shovel 100. The object to be detected may include, for example, a person, an animal, a vehicle, a construction machine, a building, a hole, and the like. Furthermore, the imaging device S6 may calculate a distance from the imaging device S6 or the shovel 100 to the recognized object. The imaging device S6 as the object detection device may include, for example, a stereo camera, a range imaging sensor, and the like. The space recognition device is, for example, a monocular camera including an image sensor such as a CCD or CMOS, and outputs a captured image to the display device 40. Furthermore, the space recognition device may be configured to calculate a distance from the space recognition device or the shovel 100 to the recognized object. Furthermore, in addition to the imaging device S6, another object detection device such as an ultrasonic sensor, a millimeter-wave radar, a light detection and ranging (LiDAR), an infrared sensor, or the like may be provided as a space recognition device. When a millimeter-wave radar, an ultrasonic sensor, a laser radar, or the like is used as the space recognition device, a large number of signals (laser light or the like) may be transmitted to the object, and the reflected signals thereof may be received to detect the distance and direction of the object from the reflected signals.

Note that the imaging device S6 may be directly connected to the controller 30 so as to be able to communicate with each other.

A boom rod pressure sensor S7R, a boom bottom pressure sensor S7B, and a boom cylinder stroke sensor S7C are attached to the boom cylinder 7. An arm rod pressure sensor S8R, an arm bottom pressure sensor S8B, and an arm cylinder stroke sensor S8C are attached to the arm cylinder 8. A bucket rod pressure sensor S9R, a bucket bottom pressure sensor S9B, and a bucket cylinder stroke sensor S9C are attached to the bucket cylinder 9. The boom rod pressure sensor S7R, the boom bottom pressure sensor S7B, the arm rod pressure sensor S8R, the arm bottom pressure sensor S8B, the bucket rod pressure sensor S9R, and the bucket bottom pressure sensor S9B are collectively referred to as "cylinder pressure sensors". The boom cylinder stroke sensor S7C, the arm cylinder stroke sensor S8C, and the bucket cylinder stroke sensor S9C are also referred to as "cylinder stroke sensors".

The boom rod pressure sensor S7R detects the pressure (boom rod pressure) of a rod-side oil chamber of the boom cylinder 7. A boom bottom pressure sensor S7B detects the pressure (boom bottom pressure) of a bottom-side oil chamber of the boom cylinder 7. A boom cylinder stroke sensor S7C detects the stroke amount (boom stroke amount) of the boom cylinder 7.

The arm rod pressure sensor S8R detects the pressure (arm rod pressure) of the rod-side oil chamber of the arm cylinder 8. The arm bottom pressure sensor S8B detects the pressure (arm bottom pressure) of the bottom-side oil chamber of the arm cylinder 8. The arm cylinder stroke sensor S8C detects the stroke amount (arm stroke amount) of the arm cylinder 8.

The bucket rod pressure sensor S9R detects the pressure (bucket rod pressure) of the rod-side oil chamber of the bucket cylinder 9. The bucket bottom pressure sensor S9B detects the pressure (bucket bottom pressure) of the bottom-side oil chamber of the bucket cylinder 9. The bucket cylinder stroke sensor S9C detects the stroke amount (bucket stroke amount) of the bucket cylinder 9.

The positioning device P1 measures the position and direction of the upper swivel body 3. The positioning device P1 is, for example, a global navigation satellite system (GNSS) compass, and detects the position and direction of the upper swivel body 3. Upon detection, a detection signal corresponding to the position and direction of the upper swivel body 3 is taken into the controller 30. Furthermore, the function of detecting the direction of the upper swivel body 3 among the functions of the positioning device P1 may be substituted by an orientation sensor attached to the upper swivel body 3.

The communicator T1 communicates with an external device through a predetermined network including a mobile communication network, a satellite communication network, an Internet network, and the like having a base station as a terminal. The communicator T1 is, for example, a mobile communication module corresponding to a mobile communication standard such as long term evolution (LTE), 4th generation (4G), 5th generation (5G), or the like, or a satellite communication module for connecting to a satellite communication network.

The machine guidance section 50 controls the shovel 100 with respect to the machine guidance function. The machine guidance section 50 transmits work information such as the distance between the target work surface and the tip of the attachment, specifically, the work portion of the end attachment, to the operator through the display device 40, the audio output device 43, and the like. The data relating to the target work surface is previously stored in the storage device 47, for example, as described above. The data relating to the target work surface is expressed in a reference coordinate system, for example. The reference coordinate system is the world geodetic system, for example. The world geodetic system is a three-dimensional orthogonal XYZ coordinate system with the origin at the center of gravity of the Earth, an X-axis in the direction of the intersection of the Greenwich meridian and the equator, a Y-axis in the direction of 90 degrees east longitude, and a Z-axis in the direction of the north pole. The operator may set any position on the construction site as the reference point, and set the target work surface according to the relative positional relationship with the reference point through the input device 42. The work portion of the bucket 6 is, for example, the claw tip of the bucket 6, the back surface of the bucket 6, or the like. When, for example, a breaker is employed instead of the bucket 6 as the end attachment, the tip of the breaker corresponds to the work portion. The machine guidance section 50 notifies the operator of the work information through the display device 40, the audio output device 43, or the like, and guides the operation of the shovel 100 by the operator through the operation device 26.

The machine guidance section 50 controls the shovel 100 for the machine control function. The machine guidance section 50 may, for example, automatically operate at least one of the boom 4, the arm 5, or the bucket 6 such that the target construction surface coincides with the tip position of the bucket 6 when the operator manually performs the excavation operation.

The machine guidance section 50 obtains information from the boom angle sensor S1, the arm angle sensor S2, the bucket angle sensor S3, the machine-machine-body inclination sensor S4, the turning state sensor S5, the imaging device S6, the positioning device P1, the communicator T1, the input device 42, and the like. The machine guidance section 50 calculates, for example, the distance between the bucket 6 and the target construction surface based on the obtained information, notifies the operator of the degree of the distance between the bucket 6 and the target construction surface by the audio output device 43 and the image displayed on the display device 40, and automatically controls the operation of the attachment such that the tip (specifically, a work portion such as the claw tip or the back surface of the bucket 6) of the attachment coincides with the target construction surface. The machine guidance section 50 includes a position calculator 51, a distance calculator 52, an information transmitter 53, control circuitry 54, and a turn-angle calculator 55 as detailed functional configurations related to the machine guidance function and the machine control function.

The position calculator 51 calculates the position of a predetermined positioning object. For example, the position calculator 51 calculates a coordinate point in the reference coordinate system of the tip of the attachment, specifically, a work portion such as the claw tip or the back of the bucket 6. Specifically, the position calculator 51 calculates the coordinate point of the work portion of the bucket 6 from the inclination angles (boom angle, arm angle, and bucket angle) of the boom 4, the arm 5, and the bucket 6.

The distance calculator 52 calculates the distance between the two positioning objects. For example, the distance calculator 52 calculates the distance between the tip of the attachment, specifically, the work portion such as the claw tip or the back of the bucket 6, and the target construction surface. The distance calculator 52 may also calculate the angle (relative angle) between the back of the bucket 6 as the work portion and the target construction surface.

The information transmitter 53 transmits (notifies) various types of information to the operator of the shovel 100 through predetermined notification means such as the display device 40 and the audio output device 43.

The control circuitry 54 individually adjusts the pilot pressure to be applied to the control valves (specifically, the control valve 173, the control valves 175L and 175R, and the control valve 174) corresponding to the plurality of hydraulic actuators (specifically, the swivel hydraulic motor 2A, the boom cylinder 7, and the bucket cylinder 9) according to the manual operation of the shovel 100 by the operator through the operation device 26. Thus, the control circuitry 54 can achieve the operation of the hydraulic actuators according to the operation performed by the operator.

The turn-angle calculator 55 calculates the turn angle of the upper swivel body 3. Thus, the controller 30 can specify the current direction of the upper swivel body 3. The turn-angle calculator 55 calculates the angle of the front-rear axis of the upper swivel body 3 with respect to a reference direction as the turn angle based on the output signal of the GNSS compass included in the positioning device P1, for example. The turn-angle calculator 55 may calculate the turn angle based on the detection signal of the turning state sensor S5. Furthermore, when the reference point is set at the construction site, the turn-angle calculator 55 may set the direction in which the reference point is viewed from a turning axis as the reference direction.

The turn angle indicates the direction in which an attachment operation surface extends with respect to the reference direction. The attachment operation surface is, for example, an imaginary plane which extends in the front-to-rear direction along the attachment and is arranged to be perpendicular to the turning plane. The turning plane is, for example, an imaginary plane including the bottom surface of a turning frame which is perpendicular to the turning axis. For example, when the controller 30 (machine guidance section 50) determines that the attachment operation surface includes the line that is normal to the target construction surface, the controller 30 determines that the upper swivel body 3 faces the target construction surface.

The turn angle calculated by the turn-angle calculator 55 may be displayed on the display device 40 as visual information by the information transmitter 53. Furthermore, the turn angle may be used as a condition for the earth-and-sand load processor 60 to measure the earth-and-sand weight (for example, to determine whether or not the upper swivel body 3 has turned).

The swivel hydraulic motor 2A includes a first port 2A1 and a second port 2A2. A hydraulic sensor 21 detects the pressure of the hydraulic oil at the first port 2A1 of the swivel hydraulic motor 2A. A hydraulic sensor 22 detects the pressure of the hydraulic oil at the second port 2A2 of the swivel hydraulic motor 2A. Detection signals corresponding to the discharge pressures detected by the hydraulic sensors 21 and 22 are taken into the controller 30.

The first port 2A1 is connected to a hydraulic oil tank via a relief valve 23. The relief valve 23 opens when the pressure on a first port 2A1 side reaches a predetermined relief pressure, and discharges the hydraulic oil on the first port 2A1 side to the hydraulic oil tank. Similarly, the second port 2A2 is connected to the hydraulic oil tank via a relief valve 24. The relief valve 24 opens when the pressure on a second port 2A2 side reaches a predetermined relief pressure, and discharges the hydraulic oil on the second port 2A2 side to the hydraulic oil tank.

### [Hydraulic system of shovel]

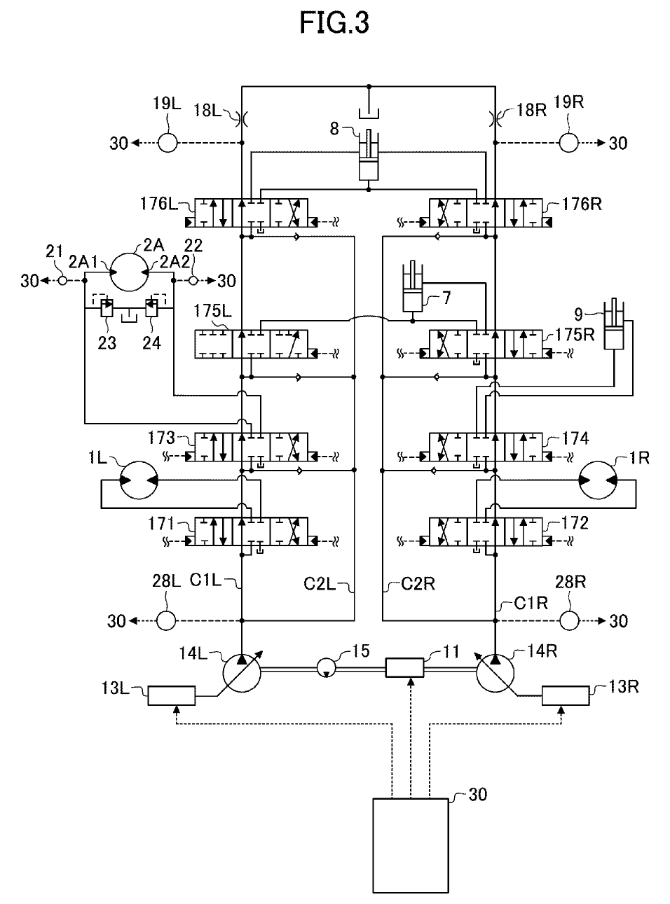

Next, a hydraulic system of the shovel 100 according to the present embodiment will be described with reference to FIG. 3. FIG. 3 is a schematic diagram illustrating an example of a configuration of a hydraulic system of the shovel according to the present embodiment. In FIG. 3, the mechanical power system, the hydraulic oil line, the pilot line, and the electric control system are indicated by double lines, solid lines, broken lines, and dotted lines, respectively, as in FIG. 2 and the like.

The hydraulic system achieved by the hydraulic circuit as illustrated in FIG. 3 circulates the hydraulic oil from the main pumps 14L and 14R driven by the engine 11 to the hydraulic oil tank via central bypass oil paths C1L and C1R and parallel oil paths C2L and C2R.

The central bypass oil path C1L starts from the main pump 14L and passes sequentially through the control valves 171, 173, 175L, and 176L arranged in the control valve 17 to reach the hydraulic oil tank.

The central bypass oil path C1R starts from the main pump 14R and passes sequentially through the control valves 172, 174, 175R, and 176R arranged in the control valve 17 to reach the hydraulic oil tank.

The control valve 171 is a spool valve for supplying the hydraulic oil discharged from the main pump 14L to the traveling hydraulic motor 1L and discharging the hydraulic oil discharged by the traveling hydraulic motor 1L to the hydraulic oil tank.

The control valve 172 is a spool valve for supplying the hydraulic oil discharged from the main pump 14R to the traveling hydraulic motor 1R and discharging the hydraulic oil discharged by the traveling hydraulic motor 1R to the hydraulic oil tank.

The control valve 173 is a spool valve for supplying the hydraulic oil discharged from the main pump 14L to the swivel hydraulic motor 2A and discharging the hydraulic oil discharged from the swivel hydraulic motor 2A to the hydraulic oil tank.

The control valve 174 is a spool valve for supplying the hydraulic oil discharged from the main pump 14R to the bucket cylinder 9 and discharging the hydraulic oil in the bucket cylinder 9 to the hydraulic oil tank.

The control valves 175L and 175R are spool valves for supplying the hydraulic oil discharged from the main pumps 14L and 14R to the boom cylinder 7 and discharging the hydraulic oil in the boom cylinder 7 to the hydraulic oil tank.

The control valves 176L and 176R are spool valves for supplying the hydraulic oil discharged from the main pumps 14L and 14R to the arm cylinder 8 and discharging the hydraulic oil in the arm cylinder 8 to the hydraulic oil tank.

The control valves 171, 172, 173, 174, 175L, 175R, 176L, and 176R respectively adjust the flow rate of the hydraulic oil supplied to and discharged from the hydraulic actuator and switch the flow direction in accordance with the pilot pressure to be applied to the pilot port.

The parallel oil path C2L supplies the hydraulic oil of the main pump 14L to the control valves 171, 173, 175L, and 176L in parallel with the central bypass oil path C1L. Specifically, the parallel oil path C2L branches from the central bypass oil path C1L on an upstream side of the control valve 171, and is configured to supply the hydraulic oil of the main pump 14L to the control valves 171, 173, 175L, and 176R in parallel. Thus, the parallel oil path C2L can supply the hydraulic oil to the control valve further downstream when the flow of the hydraulic oil through the central bypass oil path C1L is restricted or blocked by any of the control valves 171, 173, and 175L.

The parallel oil path C2R supplies the hydraulic oil of the main pump 14R to the control valves 172, 174, 175R, and 176R in parallel with the central bypass oil path C1R. Specifically, the parallel oil path C2R branches from the central bypass oil path C1R on the upstream side of the control valve 172, and is configured to supply the hydraulic oil of the main pump 14R to the control valves 172, 174, 175R, and 176R in parallel. Thus, the parallel oil path C2R can supply the hydraulic oil to the control valve further downstream when the flow of the hydraulic oil through the central bypass oil path C1R is restricted or blocked by any one of the control valves 172, 174, or 175R.

The regulators 13L and 13R adjust the discharge amounts of the main pumps 14L and 14R by adjusting the inclination angles of the swash plates of the main pumps 14L and 14R under the control of the controller 30, respectively.

The discharge pressure sensor 28L detects the discharge pressure of the main pump 14L. Upon detection, a detection signal corresponding to the detected discharge pressure is taken into the controller 30. The same applies to the discharge pressure sensor 28R. Thus, the controller 30 can control the regulators 13L and 13R in accordance with the discharge pressures of the main pumps 14L and 14R.

A negative control orifice (hereinafter referred to as "negative control throttle") 18L is provided in the central bypass oil path C1L between the control valve 176L located at the most downstream and the hydraulic oil tank. Similarly, a negative control orifice 18R is provided in the central bypass oil path C1R between the control valve 176R located at the most downstream and the hydraulic oil tank. Thus, the flows of the hydraulic oil discharged by the main pumps 14L and 14R are restricted by the negative control throttles 18L and 18R. The negative control throttles 18L and 18R generate control pressure (hereinafter referred to as "negative control pressure") for controlling the regulators 13L and 13R.

Negative control pressure sensors 19L and 19R detect the negative control pressure. A detection signal corresponding to the negative control pressure detected by the negative control pressure sensors 19L and 19R is taken into the controller 30.

The controller 30 may control the regulators 13L and 13R in accordance with the discharge pressures of the main pumps 14L and 14R detected by the discharge pressure sensors 28L and 28R to adjust the discharge amounts of the main pumps 14L and 14R. For example, the controller 30 may control the regulator 13L in accordance with an increase in the discharge pressure of the main pump 14L to adjust the swash plate inclination angle of the main pump 14L to decrease the discharge amounts. The same applies to the regulator 13R. Thus, the controller 30 can control the total horsepower of the main pumps 14L and 14R such that absorbed horsepower of the main pumps 14L and 14R represented by the product of the discharge pressures and the discharge amounts does not exceed output horsepower of the engine 11.

The controller 30 may control the regulators 13L and 13R in accordance with the negative control pressures detected by the negative control pressure sensors 19L and 19R to adjust the discharge amounts of the main pumps 14L and 14R. For example, the controller 30 decreases the discharge amounts of the main pumps 14L and 14R as the negative control pressures increase, and increases the discharge amounts of the main pumps 14L and 14R as the negative control pressures decrease.

Specifically, in a standby state (state as illustrated in FIG. 3) in which none of the hydraulic actuators of the shovel 100 is being operated, the hydraulic oil discharged from the main pumps 14L and 14R passes through the central bypass oil paths C1L and C1R to reach the negative control throttles 18L and 18R. The flow of the hydraulic oil discharged from the main pumps 14L and 14R increases the negative control pressure generated upstream of the negative control throttles 18L and 18R. As a result, the controller 30 decreases the discharge amounts of the main pumps 14L and 14R to an allowable minimum discharge amount, and suppresses a pressure loss (pumping loss) when the discharged hydraulic oil passes through the central bypass oil paths C1L and C1R.

In contrast to this, when any of the hydraulic actuators is operated through the operation device 26, the hydraulic oil discharged from the main pumps 14L and 14R flows into the hydraulic actuator to be operated through the control valve corresponding to the hydraulic actuator to be operated. The flow of the hydraulic oil discharged from the main pumps 14L and 14R decreases or disappears the amount reaching the negative control throttles 18L and 18R, and decreases the negative control pressure generated upstream of the negative control throttles 18L and 18R. As a result, the controller 30 increases the discharge amounts of the main pumps 14L and 14R, circulates sufficient hydraulic oil to the hydraulic actuator to be operated, and reliably drives the hydraulic actuator to be operated.

### [Details of configuration of machine control function of shovel]

Next, details of the configuration of the machine control function of the shovel 100 will be described with reference to FIGS. 4A to 4C. FIGS. 4A to 4C are diagrams schematically illustrating an example of a component related to an operation system in the hydraulic system of the shovel according to the present embodiment.

Specifically, FIG. 4A is a diagram illustrating an example of a pilot circuit for applying pilot pressure to control valves 175L and 175R for hydraulically controlling the boom cylinder 7. FIG. 4B is a diagram illustrating an example of a pilot circuit for applying pilot pressure to the control valve 174 for hydraulically controlling the bucket cylinder 9. FIG. 4C is a diagram illustrating an example of the pilot circuit for applying pilot pressure to the control valve 173 for hydraulically controlling the swivel hydraulic motor 2A.

As illustrated in FIG. 4A, the lever device 26A is used by an operator or the like to operate the boom cylinder 7 corresponding to the boom 4. The lever device 26A outputs pilot pressure corresponding to the operation contents to the secondary side by utilizing hydraulic oil discharged from the pilot pump 15.

The shuttle valve 32AL includes two inlet ports connected to a secondary-side pilot line of the lever device 26A and a secondary-side pilot line of the proportional valve 31AL corresponding to an operation (hereinafter referred to as "boom-up operation") in a raising direction of the boom 4, respectively, and an outlet port connected to a right pilot port of the control valve 175L and a left pilot port of the control valve 175R.

The shuttle valve 32AR includes two inlet ports connected to the secondary-side pilot line of the lever device 26A and the secondary-side pilot line of the proportional valve 31AR corresponding to an operation (hereinafter referred to as "boom-down operation") in a downward direction of the boom 4, respectively, and an outlet port connected to a right pilot port of the control valve 175R.

That is, the lever device 26A causes a pilot pressure corresponding to the operation contents (for example, the direction of operation and the amount of operation) to be applied to the pilot ports of the control valves 175L and 175R via the shuttle valves 32AL and 32AR. Specifically, when the boom-up operation is performed, the lever device 26A outputs a pilot pressure corresponding to the operation amount to one inlet port of the shuttle valve 32AL and causes the pilot pressure to be applied on the right pilot port of the control valve 175L and the left pilot port of the control valve 175R via the shuttle valve 32AL. When the boom is lowered, the lever device 26A outputs a pilot pressure corresponding to the operation amount to one inlet port of the shuttle valve 32AR and causes the pilot pressure to be applied to the right pilot port of the control valve 175R via the shuttle valve 32AR.

The proportional valve 31AL operates in response to a control current input from the controller 30. Specifically, the proportional valve 31AL outputs a pilot pressure corresponding to the control current input from the controller 30 to the other inlet port of the shuttle valve 32AL by using hydraulic oil discharged from the pilot pump 15. Thus, the proportional valve 31AL can adjust the pilot pressure to be applied to the right pilot port of the control valve 175L and the left pilot port of the control valve 175R via the shuttle valve 32AL.

The proportional valve 31AR operates in response to the control current input from the controller 30. Specifically, the proportional valve 31AR outputs a pilot pressure corresponding to the control current input from the controller 30 to the other inlet port of the shuttle valve 32AR by using hydraulic oil discharged from the pilot pump 15. Thus, the proportional valve 31AR can adjust the pilot pressure to be applied to the right pilot port of the control valve 175R via the shuttle valve 32AR.

That is, the proportional valves 31AL and 31AR can adjust the pilot pressure output to the secondary side such that the control valves 175L and 175R can be adjusted to desired valve positions regardless of the operation state of the lever device 26A.

Similar to the proportional valve 31AL, a proportional valve 33AL functions as a control valve for machine control. The proportional valve 33AL is disposed in a conduit connecting the operation device 26 and the shuttle valve 32AL, and is configured such that the flow path area of the conduit can be changed. In the present embodiment, the proportional valve 33AL operates in response to a control command output from the controller 30. Therefore, the controller 30 can reduce the pressure of the hydraulic oil discharged from the operation device 26 and supply the reduced pressure to the pilot port of the corresponding control valve in the control valve 17 via the shuttle valve 32AL independently of the operation of the operation device 26 by the operator.

Similarly, a proportional valve 33AR functions as a control valve for the machine control. The proportional valve 33AR is disposed in a conduit connecting the operation device 26 and the shuttle valve 32AR, and is configured such that the flow path area of the conduit can be changed. In the present embodiment, the proportional valve 33AR operates in response to a control command output from the controller 30. Therefore, the controller 30 can reduce the pressure of the hydraulic oil discharged from the operation device 26 and supply the reduced pressure to the pilot port of the corresponding control valve in the control valve 17 via the shuttle valve 32AR independently of the operation of the operation device 26 by the operator.

The operation pressure sensor 29A detects the operation content of the lever device 26A by the operator in the form of pressure (operating pressure). A detection signal corresponding to the operating pressure detected by the operation pressure sensor 29A is taken into the controller 30. Thus, the controller 30 can grasp the operation contents of the lever device 26A.

The controller 30 can supply the hydraulic oil discharged from the pilot pump 15 to the right pilot port of the control valve 175L and the left pilot port of the control valve 175R via the proportional valve 31AL and the shuttle valve 32AL independently of the boom-up operation of the lever device 26A by the operator. The controller 30 can supply the hydraulic oil discharged from the pilot pump 15 to the right pilot port of the control valve 175R via the proportional valve 31AR and the shuttle valve 32AR independently of the boom-down operation of the lever device 26A by the operator. That is, the controller 30 can automatically control the operation of raising and lowering the boom 4. The controller 30 can forcibly stop the operation of the hydraulic actuator corresponding to the specific operation device 26 even when the operation of the specific operation device 26 is being performed.

The proportional valve 33AL operates in response to a control command (current command) output from the controller 30. Then, the pilot pressure by the hydraulic oil introduced from the pilot pump 15 to the right pilot port of the control valve 175L and the left pilot port of the control valve 175R via the lever device 26A, the proportional valve 33AL, and the shuttle valve 32AL is reduced. The proportional valve 33AR operates in response to a control command (current command) output from the controller 30. Then, the pilot pressure by the hydraulic oil introduced from the pilot pump 15 to the right pilot port of the control valve 175R via the lever device 26A, the proportional valve 33AR, and the shuttle valve 32AR is reduced. The proportional valves 33AL and 33AR can adjust the pilot pressure such that the control valves 175L and 175R can be adjusted to desired valve positions.

With this configuration, the controller 30 can forcibly stop a closing operation of the boom 4 by reducing the pilot pressure to be applied to the pilot port on an upward-side of the control valve 175 (the left pilot port of the control valve 175L and the right pilot port of the control valve 175R) as necessary even when the boom-up operation is being performed by the operator. The same applies to the case where the boom-down operation of the boom 4 is forcibly stopped when the boom-down operation is being performed by the operator.

Alternatively, the controller 30 may forcibly stop the boom-up operation of the boom 4 by controlling the proportional valve 31AR, increasing the pilot pressure to be applied to the pilot port on the downward-side of the control valve 175 (the right pilot port of the control valve 175R) located on an opposite side of the pilot port on the upward-side of the control valve 175, and forcibly returning the control valve 175 to a neutral position as necessary even when the raising operation of the boom 4 is being performed by the operator. In this case, the proportional valve 33AL may be omitted. The same applies to the case where the boom-down operation of the boom 4 is forcibly stopped when the boom-down operation is being performed by the operator.

As illustrated in FIG. 4B, the lever device 26B is used by the operator or the like to operate the bucket cylinder 9 corresponding to the bucket 6. The lever device 26B outputs the pilot pressure corresponding to the operation contents to the secondary side by using the hydraulic oil discharged from the pilot pump 15.

The shuttle valve 32BL includes two inlet ports connected to the secondary-side pilot line of the lever device 26B and the secondary-side pilot line of the proportional valve 31BL corresponding to an operation (hereinafter referred to as "bucket-closing operation") in a closing direction of the bucket 6, respectively, and an outlet port connected to the left pilot port of the control valve 174.

The shuttle valve 32BR includes two inlet ports connected to the secondary-side pilot line of the lever device 26B and the secondary-side pilot line of the proportional valve 31BR corresponding to an operation (hereinafter referred to as "bucket-opening operation") in the opening direction of the bucket 6, respectively, and an outlet port connected to the right pilot port of the control valve 174.

That is, the lever device 26B causes a pilot pressure corresponding to the operation contents to be applied to the pilot port of the control valve 174 via the shuttle valves 32BL and 32BR. Specifically, when the bucket-closing operation is performed, the lever device 26B outputs a pilot pressure corresponding to the operation amount to one inlet port of the shuttle valve 32BL and causes the pilot pressure to be applied to the left pilot port of the control valve 174 via the shuttle valve 32BL. When the bucket-opening operation is performed, the lever device 26B outputs a pilot pressure corresponding to the operation amount to one inlet port of the shuttle valve 32BR and causes the pilot pressure to be applied to the right pilot port of the control valve 174 via the shuttle valve 32BR.

The proportional valve 31BL operates in response to the control current input from the controller 30. Specifically, the proportional valve 31BL outputs a pilot pressure corresponding to the control current input from the controller 30 to the other pilot port of the shuttle valve 32BL by utilizing hydraulic oil discharged from the pilot pump 15. Thus, the proportional valve 31BL can adjust the pilot pressure to be applied to the left pilot port of the control valve 174 via the shuttle valve 32BL.

The proportional valve 31BR operates in response to the control current input from the controller 30. Specifically, the proportional valve 31BR outputs a pilot pressure corresponding to the control current input from the controller 30 to the other pilot port of the shuttle valve 32BR by utilizing hydraulic oil discharged from the pilot pump 15. Thus, the proportional valve 31BR can adjust the pilot pressure to be applied to the right pilot port of the control valve 174 via the shuttle valve 32BR.

That is, the proportional valves 31BL and 31BR can adjust the pilot pressure output to the secondary side such that the control valve 174 can be adjusted to a desired valve position regardless of the operation state of the lever device 26B.

Similar to the proportional valve 31BL, a proportional valve 33BL functions as a control valve for machine control. The proportional valve 33BL is disposed in a conduit connecting the operation device 26 and the shuttle valve 32BL, and is configured to change the flow path area of the conduit. In the present embodiment, the proportional valve 33BL operates in response to a control command output from the controller 30. Therefore, the controller 30 can reduce the pressure of the hydraulic oil discharged from the operation device 26 and supply the reduced pressure to the pilot port of the corresponding control valve in the control valve 17 via the shuttle valve 32BL independently of the operation of the operation device 26 by the operator.

Similarly, a proportional valve 33BR functions as a control valve for machine control. The proportional valve 33BR is disposed in a conduit connecting the operation device 26 and the shuttle valve 32BR, and is configured such that the flow path area of the conduit can be changed. In the present embodiment, the proportional valve 33BR operates in response to a control command output from the controller 30. Therefore, the controller 30 can reduce the pressure of the hydraulic oil discharged from the operation device 26 and supply the reduced pressure to the pilot port of the corresponding control valve in the control valve 17 via the shuttle valve 32BR independently of the operation of the operation device 26 by the operator.

An operation pressure sensor 29B detects the operation of the lever device 26B by the operator in the form of pressure (operation pressure). The detection signal corresponding to the operation pressure detected by the operation pressure sensor 29B is taken into the controller 30. Thus, the controller 30 can grasp the operation contents of the lever device 26B.

The controller 30 can supply the hydraulic oil discharged from the pilot pump 15 to the left pilot port of the control valve 174 via the proportional valve 31BL and the shuttle valve 32BL independently of the bucket-closing operation of the lever device 26B by the operator. The controller 30 can supply the hydraulic oil discharged from the pilot pump 15 to the right pilot port of the control valve 174 via the proportional valve 31BR and the shuttle valve 32BR independently of the bucket-opening operation of the lever device 26B by the operator. That is, the controller 30 can automatically control the bucket-closing operation or the bucket-opening operation of the bucket 6. The controller 30 can forcibly stop the operation of the hydraulic actuator corresponding to the specific operation device 26 even when the operation of the specific operation device 26 is being performed.

It should be noted that the operation of the proportional valves 33BL and 33BR for forcibly stopping the operation of the bucket 6 when the bucket-closing operation or the bucket-opening operation is being performed by the operator is the same as the operation of the proportional valves 33AL and 33AR for forcibly stopping the operation of the boom 4 when the boom-up operation or the boom-down operation is being performed by the operator, and thus description thereof is omitted.

As illustrated in FIG. 4C, the lever device 26C is used by an operator or the like to operate the swivel hydraulic motor 2A corresponding to the upper swivel body 3 (turner 2). The lever device 26C outputs a pilot pressure corresponding to the operation contents to the secondary side by utilizing hydraulic oil discharged from the pilot pump 15.

The shuttle valve 32CL includes two inlet ports connected to the secondary-side pilot line of the lever device 26C corresponding to a leftward turn operation (hereinafter referred to as "left-turn operation") of the upper swivel body 3 and the secondary-side pilot line of the proportional valve 31CL, respectively, and an outlet port connected to the left pilot port of the control valve 173.

The shuttle valve 32CR includes two inlet ports connected to the secondary-side pilot line of the lever device 26C corresponding to a rightward turn operation (hereinafter referred to as "right-turn operation") of the upper swivel body 3 and the secondary-side pilot line of the proportional valve 31CR, respectively, and an outlet port connected to a right pilot port of the control valve 173.

That is, the lever device 26C causes a pilot pressure corresponding to the operation contents in the left-right direction to be applied to the pilot port of the control valve 173 via the shuttle valves 32CL and 32CR. Specifically, when the leftward turn operation is performed, the lever device 26C outputs a pilot pressure corresponding to the operation amount to one inlet port of the shuttle valve 32CL and causes the pilot pressure to be applied to the left pilot port of the control valve 173 via the shuttle valve 32CL. When the rightward turn operation is performed, the lever device 26C outputs a pilot pressure corresponding to the operation amount to one inlet port of the shuttle valve 32CR and causes the pilot pressure to be applied to the right pilot port of the control valve 173 via the shuttle valve 32CR.

The proportional valve 31CL operates in response to a control current input from the controller 30. Specifically, the proportional valve 31CL outputs a pilot pressure corresponding to the control current input from the controller 30 to the other pilot port of the shuttle valve 32CL by using hydraulic oil discharged from the pilot pump 15. Thus, the proportional valve 31CL can adjust the pilot pressure to be applied to the left pilot port of the control valve 173 via the shuttle valve 32CL.

The proportional valve 31CR operates in response to the control current input from the controller 30. Specifically, the proportional valve 31CR outputs a pilot pressure corresponding to the control current input from the controller 30 to the other pilot port of the shuttle valve 32CR by using hydraulic oil discharged from the pilot pump 15. Thus, the proportional valve 31CR can adjust the pilot pressure to be applied to the right pilot port of the control valve 173 via the shuttle valve 32CR.

That is, the proportional valves 31CL and 31CR can adjust the pilot pressure output to the secondary side such that the control valve 173 can be adjusted to a desired valve position regardless of the operation state of the lever device 26C.

A proportional valve 33CL functions as a control valve for machine control similarly to the proportional valve 31CL. The proportional valve 33CL is disposed in a conduit connecting the operation device 26 and the shuttle valve 32CL, and is configured such that the flow path area of the conduit can be changed. In the present embodiment, the proportional valve 33CL operates in response to the control command output from the controller 30. Therefore, the controller 30 can reduce the pressure of the hydraulic oil discharged from the operation device 26 and supply the reduced pressure to the pilot port of the corresponding control valve in the control valve 17 via the shuttle valve 32CL independently of the operation of the operation device 26 by the operator.

Similarly, a proportional valve 33CR functions as a control valve for machine control. The proportional valve 33CR is disposed in a conduit connecting the operation device 26 and the shuttle valve 32CR, and is configured such that the flow path area of the conduit can be changed. In the present embodiment, the proportional valve 33CR operates in response to a control command output from the controller 30. Therefore, the controller 30 can reduce the pressure of the hydraulic oil discharged from the operation device 26 and supply the reduced pressure to the pilot port of the corresponding control valve in the control valve 17 via the shuttle valve 32CR independently of the operation of the operation device 26 by the operator.

An operation pressure sensor 29C detects the operation state of the lever device 26C by the operator in the form of pressure (operation pressure). A detection signal corresponding to the operation pressure detected by the operation pressure sensor 29C is taken into the controller 30. Thus, the controller 30 can grasp the operation contents of the lever device 26C in the left-right direction.

The controller 30 can supply the hydraulic oil discharged from the pilot pump 15 to the pilot port on the left side of the control valve 173 via the proportional valve 31CL and the shuttle valve 32CL, independently of the left-turn operation of the lever device 26C by the operator. The controller 30 can supply the hydraulic oil discharged from the pilot pump 15 to the pilot port on the right side of the control valve 173 via the proportional valve 31CR and the shuttle valve 32CR, independently of the right-turn operation of the lever device 26C by the operator. That is, the controller 30 can automatically control a left-right turn operation of the upper swivel body 3. The controller 30 can forcibly stop the operation of the hydraulic actuator corresponding to the specific operation device 26 even when the specific operation device 26 is being operated.

The operation of the proportional valves 33CL and 33CR for forcibly stopping the operation of the upper swivel body 3 when the operator is performing the turn operation is the same as the operation of the proportional valves 33AL and 33AR for forcibly stopping the operation of the boom 4 when the operator is performing the boom-up operation or the boom-down operation, and thus description thereof is omitted.

The shovel 100 may further be provided with a configuration for automatically opening and closing the arm 5 and a configuration for automatically moving the lower traveling body 1 forward or backward. In this case, the components of the hydraulic system relating to the operation system of the arm cylinder 8, the components relating to the operation system of the traveling hydraulic motor 1L, and the components relating to the operation system of the traveling hydraulic motor 1R may be configured similarly to the components relating to the operation system of the boom cylinder 7 and the like (see FIGS. 4A to 4C).

The shovel 100 may communicate with an external device (not illustrated) indirectly or directly, for example, by using the communicator T1.

The shovel 100 may be configured to be remotely operated (remote operation) from the outside of the shovel 100 instead of being operated by an operator on board the cab 10. When the shovel 100 is remotely operated, the interior of the cab 10 may be unmanned. Hereinafter, description will be made on the assumption that the operation performed by the operator includes at least one of the operation of the operation device 26 by the operator of the cab 10 or the remote operation by an external operator.

The remote control includes, for example, a mode in which the shovel 100 is operated by an operation input concerning the actuator of the shovel 100 performed by a predetermined external device. In this case, the shovel 100 may transmit, for example, image information (captured image) output by the front camera S6F for capturing an image in front of the upper swivel body 3 for remote control to the external device through the communicator T1 described in the following. The external device may display the received image information (captured image) on a display device (hereinafter referred to as "remote control display device") provided in its own device. In addition, various information images (information screens) displayed on the display device 40 inside the cab 10 of the shovel 100 may similarly be displayed on the remote control display device of the external device. Thus, the operator of the external device can remotely control the shovel 100 while confirming, for example, display contents such as a captured image and an information screen representing a state around the shovel 100 displayed on the remote control display device. The shovel 100 may operate an actuator in accordance with a remote control signal representing the content of the remote control received from the external device by the communicator T1 to drive the driven elements such as the lower traveling body 1 (left and right crawlers), the upper swivel body 3, the boom 4, the arm 5, and the bucket 6.

The remote control may include, for example, a mode in which the shovel 100 is operated by audio input, gesture input, or the like from the outside to the shovel 100 by a person (for example, a worker) around the shovel 100. Specifically, the shovel 100 recognizes a voice spoken by a nearby worker or the like and a gesture performed by the worker or the like through an audio input device (for example, a microphone), a gesture input device (for example, an imaging apparatus), or the like mounted on the shovel 100. The shovel 100 may operate an actuator in accordance with the contents of the recognized voice, gesture, or the like to drive the driven elements such as the lower traveling body 1 (left and right crawlers), the upper swivel body 3, the boom 4, the arm 5, and the bucket 6.

The operation device 26 (including a left operation lever, a right operation lever, a left traveling lever, and a right traveling lever) may be an electric type that outputs an electric signal rather than a hydraulic pilot type that outputs a pilot pressure. In this case, the electric signal from the operation device 26 is input to the controller 30, and the controller 30 controls each of the control valves 171 to 176 in the control valve 17 in accordance with the input electric signal, thereby achieving the operation of the various hydraulic actuators in accordance with the contents of the operation with respect to the operation device 26. For example, the control valves 171 to 176 in the control valve 17 may be an electromagnetic solenoid type spool valve driven by a command from the controller 30. Furthermore, for example, a solenoid valve that operates in accordance with an electric signal from the controller 30 may be disposed between the pilot pump 15 and the pilot port of each of the control valves 171 to 176. In this case, when a manual operation by using the electric operation device 26 is performed, the controller 30 controls the solenoid valve in accordance with an electric signal corresponding to the operation amount (for example, a lever operation amount) to increase or decrease the pilot pressure, thereby operating each of the control valves 171 to 176 in accordance with the contents of the operation with respect to the operation device 26.

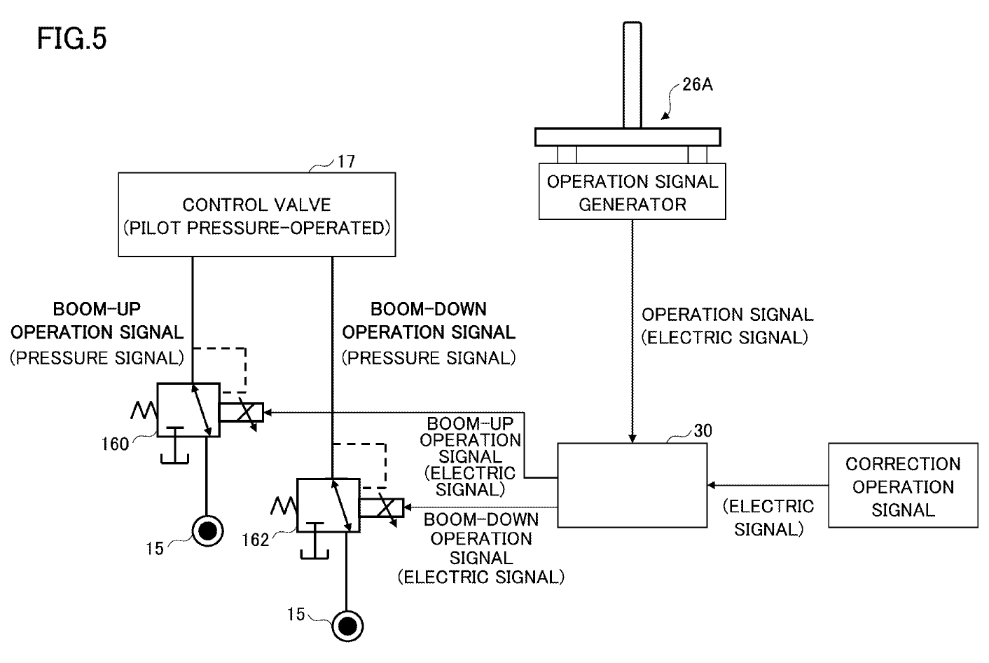

FIG. 5 is a diagram illustrating an example of a configuration of an electric operation system of the shovel according to the present embodiment. Here, the operation device 26 is an electromagnetic operation lever, and the controller 30 controls the pilot pressure applied to the control valve 17 (control valve 175) to suppress the vibration of the boom 4.

When an electric operation system including an electric operation lever is employed, the controller 30 can readily perform an autonomous control function as compared to a case where a hydraulic operation system including a hydraulic operation lever is employed. The electric operation system as illustrated in FIG. 5 is an example of a boom operation system, and mainly includes the pilot pressure-operated control valve 17, the lever device 26A as an electric operation lever, the controller 30, a solenoid valve 160 for boom-up operation, and a solenoid valve 162 for boom-down operation. The electric operation system as illustrated in FIG. 5 can be similarly applied to an arm operation system, a bucket operation system, and the like. Hereinafter, an electromagnetic operation lever or an electric operation lever will be simply referred to as an "electric lever". The lever device 26A is an example of the electric lever.

The pilot pressure-operated control valve 17 includes the control valve 175 (see FIG. 3) for the boom cylinder 7, the control valve 176 (see FIG. 3) for the arm cylinder 8, the control valve 174 (see FIG. 3) for the bucket cylinder 9, and the like. The solenoid valve 160 is configured to be able to adjust the flow path area of a conduit connecting the pilot pump 15 and the upward-side pilot port of the control valve 175. The solenoid valve 162 is configured to be able to adjust the flow path area of a conduit connecting the pilot pump 15 and the downward-side pilot port of the control valve 175.

When a manual operation is performed, the controller 30 generates a boom-up operation signal (electric signal) or a boom-down operation signal (electric signal) in accordance with an operation signal (electric signal) output from the operation signal generator of the lever device 26A. The operation signal output from the operation signal generator of the lever device 26A is an electric signal which changes in accordance with an operation amount and an operation direction of the lever device 26A.

Specifically, when the lever device 26A is operated in the boom-up direction, the controller 30 outputs to the solenoid valve 160 a boom-up operation signal (electric signal) in accordance with an operation amount of the lever. The solenoid valve 160 adjusts a flow path area in accordance with the boom-up operation signal (electric signal) and controls a pilot pressure as a boom-up operation signal (pressure signal) which is to be applied to the upward-side pilot port of the control valve 175. Similarly, when the lever device 26A is operated in a boom-down direction, the controller 30 outputs to the solenoid valve 162 a boom-down operation signal (electric signal) in accordance with an operation amount of the lever. The solenoid valve 162 adjusts a flow path area in accordance with the boom-down operation signal (electric signal) and controls a pilot pressure as the boom-down operation signal (pressure signal) which is to be applied to the downward-side pilot port of the control valve 175.

When the autonomous control is executed, the controller 30 generates, for example, a boom-up operation signal (electric signal) or a boom-down operation signal (electric signal) in accordance with a correction operation signal (electric signal) instead of in accordance with an operation signal (electric signal) output from the operation signal generator of the lever device 26A. The correction operation signal may be an electric signal generated by the controller 30 or an electric signal generated by an external control apparatus other than the controller 30.

### [Details of configuration of earth-and-sand load detection function of shovel]

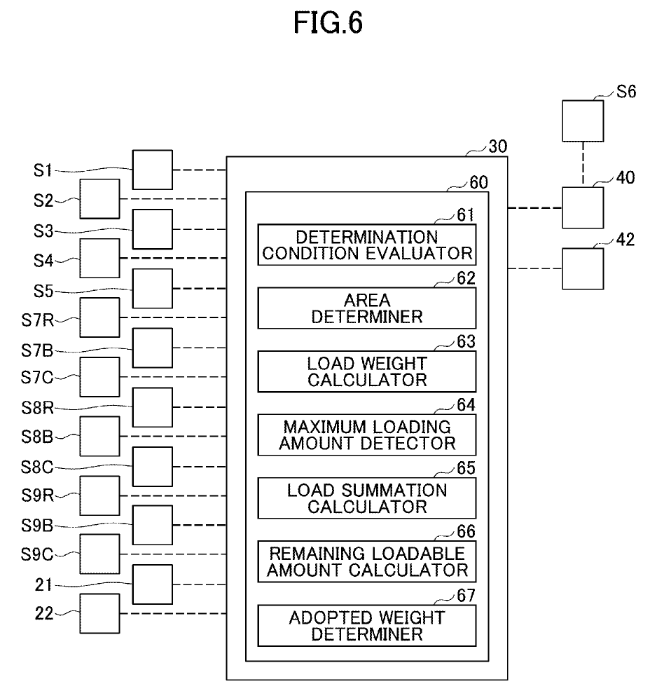

Next, details of the configuration of the earth-and-sand load detection function of the shovel 100 according to the present embodiment will be described with reference to FIG. 6. FIG. 6 is a schematic diagram illustrating an example of components relating to the earth-and-sand load detection function of the shovel according to the present embodiment.

In addition to the configuration described above, the controller 30 includes an earth-and-sand load processor 60 as a functional section related to the function of detecting the load of the earth and sand excavated by the bucket 6.

The earth-and-sand load processor 60 includes the determination-condition evaluator 61, an area determiner 62, a load weight calculator 63, a maximum loading amount detector 64, a load summation calculator 65, a remaining loadable amount calculator 66, and an adopted weight determiner 67.

Here, an example of an operation of loading earth and sand (loaded object) to a dump truck by the shovel 100 according to the present embodiment will be described.

First, the shovel 100 excavates earth and sand by the bucket 6 by controlling the attachment at an excavation position (excavation operation). Next, the shovel 100 performs a boom-up operation of raising the boom 4 until the bottom of the bucket 6 reaches a desired height from the ground, turns the upper swivel body 3, and moves the bucket 6 from the excavation position to an unloading position (turn operation). A bed of the dump truck is disposed below the unloading position. Next, the shovel 100 loads earth and sand in the bucket 6 onto the bed of the dump truck by releasing the earth and sand in the bucket 6 by controlling the attachment at the unloading position (unloading operation). Next, the shovel 100 turns the upper swivel body 3, and moves the bucket 6 from the unloading position to the excavation position (turn operation). By repeating these operations, the shovel 100 loads the excavated earth and sand onto the bed of the dump truck.

A determination-condition evaluator 61 determines whether or not the state of the shovel 100 satisfies a predetermined condition (determination condition) for determining the weight of earth and sand (an example of an object) loaded in the bucket 6 as a measurement result. In the present embodiment, after the bucket 6 is loaded with earth and sand, the determination-condition evaluator 61 determines whether or not a detection signal (an example of the detection information) relating to the raising operation of the boom 4 satisfies a plurality of determination conditions.

More specifically, the determination-condition evaluator 61 determines whether a detection signal (an example of the detection information) relating to the raising operation of the boom 4 satisfies all of the plurality of determination conditions, satisfies a part of the plurality of determination conditions, or does not satisfy any of the plurality of determination conditions. The plurality of determination conditions are the first to fourth conditions described in the following.

A specific determination method by the determination-condition evaluator 61 will be described in the following.

For example, the first condition among the plurality of determination conditions determined by the determination-condition evaluator 61 is a condition relating to the boom-up operation. Specifically, the determination-condition evaluator 61 determines that the first condition is satisfied when the boom-up operation performed by the operator is stopped. The determination-condition evaluator 61 may determine whether or not the boom-up operation is stopped based on the pilot pressure corresponding to the operation state of the boom 4.

The second condition among the plurality of determination conditions determined by the determination-condition evaluator 61 is a condition related to the height of the bucket 6. Specifically, the determination-condition evaluator 61 determines that the second condition is satisfied when the height of the bucket 6 reaches a predetermined height. The height of the bucket 6 is a distance from the ground to the bottom of the bucket 6. The height of the bucket 6 may be calculated by the distance calculator 52.

The third condition among the plurality of determination conditions determined by the determination-condition evaluator 61 is a condition related to the raising amount of the boom 4. Specifically, the determination-condition evaluator 61 determines that the third condition is satisfied when the raising amount of the boom 4 is sufficient. The raising amount of the boom 4 is a height difference between the height of the boom 4 when the excavation operation is completed and the current height of the boom 4.

The fourth condition among the plurality of determination conditions determined by the determination-condition evaluator 61 is a condition related to the acceleration at which the boom 4 moves. Specifically, the determination-condition evaluator 61 determines that the fourth condition is satisfied when the acceleration at which the boom 4 moves is within a predetermined range. The acceleration at which the boom 4 moves may be the angular acceleration around a foot pin of the boom 4.

Furthermore, the fourth condition may be a condition related to the acceleration at which the arm 5 moves. For example, the determination-condition evaluator 61 may calculate the angular acceleration of the arm 5 based on the arm angle detected by the arm angle sensor S2, and determine that the fourth condition is satisfied when the angular acceleration of the arm 5 is not less than a predetermined lower limit value and not more than a predetermined upper limit value and the acceleration at which the arm 5 moves is within a predetermined range.

The determination-condition evaluator 61 determines the measurement accuracy of the earth-and-sand weight based on the determination condition determined to be satisfied by the detection signal among the plurality of determination conditions. For example, when the determination-condition evaluator 61 determines that all the conditions among the plurality of determination conditions are satisfied, the measurement accuracy of the earth-and-sand weight may be determined to be the highest. The determination-condition evaluator 61 may determine that the measurement accuracy of the earth-and-sand weight is medium accuracy when the detection signal satisfies a part of the determination conditions among the plurality of determination conditions.

When the determination-condition evaluator 61 determines that the determination condition is satisfied, the earth-and-sand load processor 60 determines the earth-and-sand weight calculated based on the detection signal by the load weight calculator 63, which will be described in the following, as the measurement result. Note that the determination-condition evaluator 61 is not limited to one detection signal, and a plurality of detection signals may be used for the determination.

The area determiner 62 determines whether or not the piston of the boom cylinder 7 exists in the cushion area at the start of the boom-up operation. In other words, the area determiner 62 determines whether or not the piston of the boom cylinder 7 has reached the cushion area at the start of the boom-up operation.

Specifically, the area determiner 62 determines that the piston of the boom cylinder 7 exists in the cushion area at the start of the boom-up operation when a value measured by the boom bottom pressure sensor S7B at the start of the boom-up operation is equal to or greater than a predetermined value. In the present embodiment, it is thus possible to automatically determine whether or not the piston of the boom cylinder 7 exists in the cushion area at the start of the boom-up operation.

Furthermore, the area determiner 62 determines whether or not the piston of the boom cylinder 7 has reached the range (cushion area) in which the cushion function activates. Specifically, the area determiner 62 may determine that the piston of the boom cylinder 7 has reached the cushion area when the boom angle detected by the boom angle sensor S1 is equal to or greater than a predetermined threshold value. Furthermore, for example, the area determiner 62 may determine that the piston of the boom cylinder 7 has reached the cushion area when an amount of boom stroke detected by the boom cylinder stroke sensor S7C is equal to or greater than the predetermined threshold value.

Furthermore, for example, the area determiner 62 may determine that the piston of the boom cylinder 7 has reached the cushion area when the amount of change in the boom rod pressure detected by the boom rod pressure sensor S7R or the amount of change in the boom bottom pressure detected by the boom bottom pressure sensor S7B is equal to or greater than a predetermined threshold value.

In this case, for example, the area determiner 62 need not necessarily be set a predetermined threshold value for the amount of change in the boom rod pressure or the boom bottom pressure in advance. In this case, the area determiner 62 may determine that the piston of the boom cylinder 7 has reached the cushion area when the amount of change in the boom bottom pressure rapidly becomes greater than the amount of change in the boom rod pressure or the boom bottom pressure in the past by referring to the operation history so far. In this manner, it is possible to automatically determine that the piston of the boom cylinder 7 has reached the cushion area.

The amount of change in the boom rod pressure and the amount of change in the boom bottom pressure are the amount of change per unit time (i.e., derivative value). As described above, the boom angle sensor S1, the boom cylinder stroke sensor S7C, the boom rod pressure sensor S7R, and the boom bottom pressure sensor S7B output detection signals relating to the raising operation of the boom 4.

The area determiner 62 may determine whether or not the piston of the boom cylinder 7 has reached the cushion area by using a plurality of determination methods among the above-described determination methods. As described above, the accuracy of the determination can be enhanced by using a plurality of determination methods together.

The area determiner 62 of the present embodiment may determine whether or not the piston of the boom cylinder 7 has reached the cushion area by any one of the above-described determination methods.

When the height of the bucket 6 is included in a measurement section for measuring the weight of the earth and sand loaded in the bucket 6, the load weight calculator 63 calculates the weight of the earth and sand in the bucket 6 based on thrust (values measured by the boom rod pressure sensor S7R and the boom bottom pressure sensor S7B) of the boom cylinder 7 derived from the detection signal from the cylinder pressure sensors and the center of gravity of earth and sand. The measurement section is a section in a height direction provided for calculating the weight of the earth and sand in the bucket 6 and is determined according to embodiments.

The earth and sand weight is calculated, for example, by balancing the torque around a boom base of the boom 4. Specifically, the thrust of the boom cylinder 7 is increased by the earth and sand in the bucket 6, and the torque around the boom base of the boom 4 calculated from the thrust of the boom cylinder 7 is also increased. The increased torque coincides with the torque calculated from the weight and center of gravity of earth and sand. As described above, the load weight calculator 63 calculates the earth and sand weight based on the thrust of the boom cylinder 7 (values measured by the boom rod pressure sensor S7R and the boom bottom pressure sensor S7B) and the center of gravity of earth and sand derived from the detection signal. The center of gravity of earth and sand is experimentally obtained in advance and stored in the controller 30.

Although the present embodiment describes an example of calculating the earth and sand weight based on the thrust of the boom cylinder 7, the calculation method of the earth and sand weight is not limited to the described method. The load weight calculator 63 according to the present embodiment may calculate the weight of the earth and sand based on the detection signal detected as the operation of the attachment. For example, the load weight calculator 63 may calculate the earth and sand weight based on the thrust of the arm cylinder 8 (values measured by the arm rod pressure sensor S8R and the arm bottom pressure sensor S8B) or may calculate the earth and sand weight based on the thrust of the bucket cylinder 9 (values measured by the bucket rod pressure sensor S9R and the bucket bottom pressure sensor S9B).

The maximum loading amount detector 64 detects the maximum loading amount of a dump truck to be loaded with earth and sand. For example, the maximum loading amount detector 64 specifies a dump truck to be loaded with earth and sand based on an image picked up by an imaging device S6. Next, the maximum loading amount detector 64 detects the maximum loading amount of the dump truck based on the image of the specified dump truck. For example, the maximum loading amount detector 64 determines the type of vehicle (size or the like) of the dump truck based on the image of the specified dump truck. The maximum loading amount detector 64 includes a table in which the type of vehicle is associated with the maximum loading amount, and determines the maximum loading amount of the dump truck based on the type of vehicle determined from the image and the table. The maximum loading amount, the type of vehicle, or the like of the dump truck may be input via the input device 42, and the maximum loading amount detector 64 may determine the maximum loading amount of the dump truck based on the input information of the input device 42.

The load summation calculator 65 calculates the weight of earth and sand loaded into the dump truck. That is, every time the earth and sand in the bucket 6 is discharged onto the bed of the dump truck, the load summation calculator 65 adds the weight of earth and sand in the bucket 6 calculated by the load weight calculator 63 to calculate a total load amount (total weight) which is the sum of the weights of earth and sand loaded onto the bed of the dump truck. When the target dump truck for loading the earth and sand becomes a new dump truck, the total load amount is reset.

The adopted weight determiner 67 determines the earth and sand weight to be adopted as the measurement result according to the state of the shovel 100 at the time when the area determiner 62 determines that the piston of the boom cylinder 7 has reached the cushion area. Specifically, when the measurement result of the earth and sand weight is not determined (the shovel 100 does not satisfy any of the plurality of determination conditions) at the time when the piston of the boom cylinder 7 is determined to have reached the cushion area, the adopted weight determiner 67 adopts the earth and sand weight calculated by the load weight calculator 63 at the time as the measurement result.

In other words, the adopted weight determiner 67 adopts the earth and sand weight calculated by the load weight calculator 63 at the time when the piston of the boom cylinder 7 has reached the cushion area as the measurement result when the state of the shovel 100 is after the start of the boom-up operation and the earth and sand weight as the measurement result has not been obtained at the time when the piston of the boom cylinder 7 has reached the cushion area. That is, the adopted weight determiner 67 obtains the earth and sand weight at the time when the piston of the boom cylinder 7 has reached the cushion area as the measurement result.

It should be noted that the earth and sand weight obtained as the measurement result by the adopted weight determiner 67 at the time may be determined that the measurement accuracy of the earth and sand weight is low because the state of the shovel 100 does not satisfy any of the plurality of determination conditions.

When the measurement result of the earth-and-sand weight is determined at the time when the area determiner 62 determines that the piston of the boom cylinder 7 has reached the cushion area, the adopted weight determiner 67 adopts the determined earth-and-sand weight as the measurement result.

In other words, when the state of the shovel 100 at the time when the piston of the boom cylinder 7 has reached the cushion area is after the start of the boom-up operation and the earth-and-sand weight is determined, the adopted weight determiner 67 adopts the determined earth-and-sand weight as the measurement result. In other words, the adopted weight determiner 67 obtains the determined earth-and-sand weight as the measurement result.

In the present embodiment, by determining the earth-and-sand weight to be obtained as the measurement result, the earth-and-sand weight corresponding to the state of the shovel 100 at the time when the piston of the boom cylinder 7 has reached the cushion area can be used as the measurement result, and the accuracy of the measurement result can be enhanced.

In addition, in the present embodiment, the earth-and-sand weight calculated by the load weight calculator 63 can be obtained as the measurement result before being influenced by a reactive force in the cushion area, and the influence of the reactive force in the cushion area can be minimized.

In addition, in the present embodiment, the load weight calculator 63 calculates the earth-and-sand weight until the piston of the boom cylinder 7 reaches the cushion area. Therefore, in the present embodiment, the measurement area in which the earth-and-sand weight is measured can be maximally widened.

The remaining loadable amount calculator 66 calculates a difference between the maximum loading amount of the dump truck detected by the maximum loading amount detector 64 and the current total load amount calculated by the load summation calculator 65 as the remaining loadable amount. The remaining loadable amount is the remaining weight of earth and sand that can be loaded into the dump truck.

The display device 40 may display the earth-and-sand weight in the bucket 6 calculated by the load weight calculator 63, the maximum loading amount of the dump truck detected by the maximum loading amount detector 64, the total load amount of the dump truck calculated by the load summation calculator 65 (total weight of earth and sand loaded onto the bed), and the remaining loadable amount of the dump truck calculated by the remaining loadable amount calculator 66 (remaining weight of earth and sand that can be loaded).

When the total load amount exceeds the maximum loading amount, a warning may be displayed on the display device 40. When the calculated earth-and-sand weight in the bucket 6 exceeds the remaining loadable amount, a warning may be displayed on the display device 40. The warning is not limited to a case where it is displayed on the display device 40, and may be an audio output by the audio output device 43. Thus, it is possible to prevent the earth and sand from being loaded in excess of the maximum loading capacity of the dump truck.

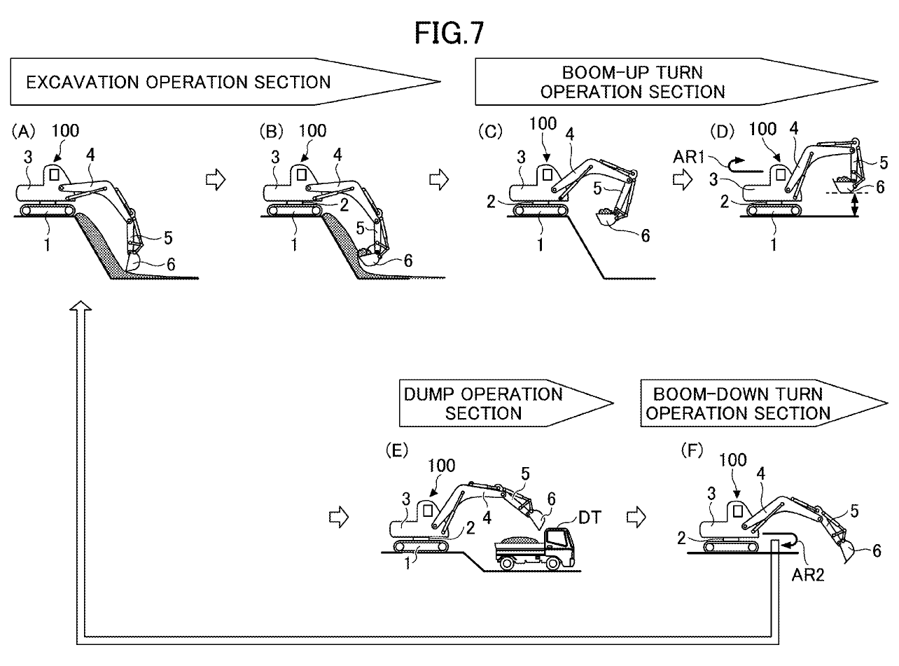

Next, an example of the operation of the shovel 100 will be described with reference to FIG. 7. FIG. 7 is a diagram for explaining the excavation and loading operation of the shovel.

First, as illustrated in (A) of FIG. 7, the operator lowers the boom. Then, the operator positions the tip of the bucket 6 to a desired height position with respect to an excavation object, and gradually closes the bucket 6 from an opened state as illustrated in (B) of FIG. 7. At this time, the excavated earth and sand enters the bucket 6.

Next, the operator raises the boom 4 to raise the bucket 6 to the position as illustrated in (C) of FIG. 7 with an upper edge of the bucket 6 substantially horizontal. At this time, the operator may raise the boom 4 and close the arm 5.

Furthermore, in the raising operation of the boom 4, when the angular acceleration around the foot pin of the boom 4 is smaller than a first threshold value when the height of the boom 4 reaches the measurement section, and the time when a change amount (differential value) of the thrust of the cylinder is determined to be smaller than a second threshold value is longer than a predetermined time, the load weight calculator 63 calculates the weight of the earth and sand in the bucket 6. Furthermore, when the determination condition for calculating the weight of the earth and sand is not satisfied, the information transmitter 53 may prompt the operator to perform an operation to satisfy the condition.

Then, as illustrated in (D) of FIG. 7, the operator raises the boom 4 until the bottom of the bucket 6 reaches a desired height from the ground. The desired height is, for example, a height greater than or equal to the height of a dump truck DT (see (E) of FIG. 7, which will be described in the following). Subsequently or simultaneously, the operator turns the upper swivel body 3 as indicated by an arrow AR1 and moves the bucket 6 to a position for discharging the earth and sand. The operation of the shovel at the time is referred to as a boom-up turn operation, and a section for the boom-up turn operation is referred to as a boom-up turn operation section.

When the boom-up turn operation is completed, the operator opens the arm 5 and the bucket 6 to discharge the earth and sand in the bucket 6 as illustrated in (E) of FIG. 7. The operation of the shovel 100 at the time is called a dump operation, and a section for the dump operation is called a dump operation section. In the dump operation, the operator may open only the bucket 6 to discharge the earth and sand.

When the dump operation is completed, the operator turns the upper swivel body 3 as illustrated by an arrow AR2 in (F) of FIG. 7, and moves the bucket 6 to just above the excavation position. At the time, simultaneously with the turning, the boom 4 is lowered to lower the bucket 6 to a desired height from the excavation object. The operation of the shovel at the time is called a boom-down turn operation, and a section for the boom-down turn operation is called a boom-down turn operation section.

The operator advances the excavation and loading operation while repeating a cycle including the "excavation operation", the "boom-up turn operation", the "dump operation", and the "boom-down turn operation".

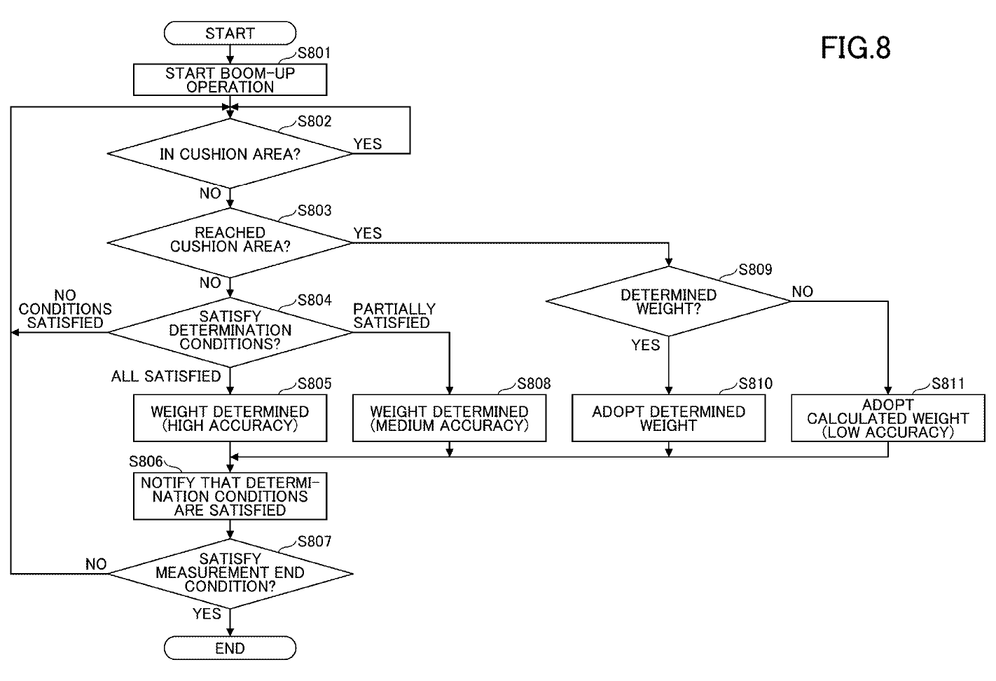

Next, an example of load weight determination processing will be described with reference to FIG. 8. FIG. 8 is a flowchart illustrating an example of the load weight determination processing.

The processing as illustrated in FIG. 8 may be executed mainly in the boom-up turn operation section as illustrated in (C) of FIG. 7.

The shovel 100 excavates earth and sand with the bucket 6 and starts the boom-up operation (step S801). When the height of the bucket 6 reaches a lower end of the measurement section, the load weight calculator 63 of the controller 30 starts calculating the weight of the earth and sand loaded in the bucket 6.

Subsequently, the earth-and-sand load processor 60 uses the area determiner 62 to determine whether or not the piston of the boom cylinder 7 exists in the cushion area at the start of the boom-up operation (step S802).

In other words, the area determiner 62 determines whether or not the state of the shovel 100 at the time when it is determined that the piston of the boom cylinder 7 has reached the cushion area is at the start of the boom-up operation.

When it is determined in step S802 that the piston of the boom cylinder 7 is in the cushion area, the controller 30 waits until the piston of the boom cylinder 7 is outside the cushion area. Therefore, at this time, there is no measurement result adopted by the adopted weight determiner 67, and the measurement result is not obtained.

When it is determined in step S802 that the piston of the boom cylinder 7 is not in the cushion area, the area determiner 62 determines whether or not the piston of the boom cylinder 7 has reached the cushion area (step S803).

When it is determined in step S803 that the piston of the boom cylinder 7 has reached the cushion area, the earth-and-sand load processor 60 proceeds to step S809 described in the following. In contrast to this, when it is determined in step S803 that the piston of the boom cylinder 7 has not reached the cushion area, the determination-condition evaluator 61 determines whether or not the detection signal relating to the raising operation of the boom 4 satisfies all, some, or none of the determination conditions.

In step S804, when it is determined that the detection signal relating to the raising operation of the boom 4 satisfies all of the plurality of determination conditions, the earth-and-sand load processor 60 determines the earth-and-sand weight calculated at the time as the measurement result of the earth-and-sand weight (step S805). Here, since all of the determination conditions are satisfied, the measurement accuracy of the determined earth-and-sand weight is high.

Subsequently, the earth-and-sand load processor 60 notifies the operator that the determination conditions are satisfied (step S806). Specifically, the earth-and-sand load processor 60 displays the measurement accuracy determined by the determination-condition evaluator 61 and the earth-and-sand weight calculated by the load weight calculator 63 on the display device 40 by the information transmitter 53.

Subsequently, the earth-and-sand load processor 60 determines whether or not the state of the shovel 100 satisfies a measurement end condition (step S807).

The measurement end condition means that the earth and sand in the bucket 6 is discharged onto the bed of the dump truck in the shovel 100, and the earth-and-sand weight in the bucket 6 calculated by the load weight calculator 63 is added to the total load amount (total weight) which is the total weight of the earth-and-sand loaded onto the bed of the dump truck.

When it is determined in step S807 that the measurement end condition is satisfied, the earth-and-sand load processor 60 ends the processing. When it is determined in step S807 that the measurement end condition is not satisfied, the earth-and-sand load processor 60 returns the processing to step S802.

When it is determined in step S804 that the detection signal relating to the raising operation of the boom 4 satisfies a part of the plurality of determination conditions, the earth-and-sand load processor 60 determines the earth-and-sand weight calculated at the point as the measurement result of the earth-and-sand weight (step S808) and proceeds to step S806. Here, since a part of the plurality of determination conditions is satisfied, the measurement accuracy of the determined earth-and-sand weight is of medium accuracy (medium-level accuracy).

Furthermore, the earth-and-sand load processor 60 may compare the accuracy of the measurement result of the retained earth-and-sand weight with the accuracy when the earth-and-sand weight is determined in step S808 and determine the measurement result of the higher accuracy as the measurement result of the earth-and-sand weight.

Specifically, for example, the earth-and-sand load processor 60 may compare the number of determination conditions satisfied when the retained earth-and-sand weight is determined with the number of determination conditions satisfied when the earth-and-sand weight is determined in step S808, and determine the earth-and-sand weight that satisfies the greater number of determination conditions as the measurement result.

Furthermore, in the present embodiment, the priority of each determination condition is given in advance, and the earth-and-sand load processor 60 may compare, for example, the priority of the determination condition satisfied when the retained earth-and-sand weight is determined with the priority of the determination condition satisfied when the earth-and-sand weight is determined in step S808. The earth-and-sand load processor 60 may determine, as the measurement result, the earth-and-sand weight having the higher priority of the determination condition satisfied.

Furthermore, when the measurement result of the retained earth-and-sand weight and the earth-and-sand weight calculated in step S808 change beyond a predetermined range, the earth-and-sand load processor 60 may determine a new earth-and-sand weight as the measurement result.

When it is determined in step S804 that the detection signal relating to the raising operation of the boom 4 does not satisfy any of the plurality of determination conditions, the earth-and-sand load processor 60 returns the processing to step S802.

When it is determined in step S803 that the piston of the boom cylinder 7 has reached the cushion area, the area determiner 62 determines whether or not the adopted weight determiner 67 has determined the earth-and-sand weight (step S809).

In other words, the adopted weight determiner 67 determines whether or not the state of the shovel 100 satisfies a plurality or a part of the plurality of determination conditions during a period from the start of the excavation and loading operation to the determination in step S803 that the piston of the boom cylinder 7 has reached the cushion area.

When it is determined in step S809 that the earth-and-sand weight has been determined, the adopted weight determiner 67 adopts the already determined earth-and-sand weight as the measurement result (step S810).

When it is determined in step S809 that the earth-and-sand weight has not been determined, the adopted weight determiner 67 adopts the earth-and-sand weight calculated by the load weight calculator 63 at the time when it is determined in step S803 that the piston of the boom cylinder 7 has reached the cushion area as the measurement result (step S811). In this case, the adopted earth-and-sand weight measurement result has low measurement accuracy because the state of the shovel 100 satisfies none of the plurality of determination conditions.

As described above, in the present embodiment, when it is determined that the piston of the boom cylinder 7 has reached the cushion area, the value obtained as the measurement result is different depending on the state of the shovel 100 at the time when the determination is made.

Specifically, in the present embodiment, when the state of the shovel 100 at the time when it is determined that the piston of the boom cylinder 7 has reached the cushion area is at the start of the boom-up operation (when the measurement of the earth-and-sand weight is started), an empty value is output as the measurement result. In other words, in the present embodiment, when the state of the work machine at the time when it is determined that the piston of the boom cylinder 7 has reached the cushion area is at the start of the attachment raising operation, the measurement result is not obtained.

In the present embodiment, it is possible to prevent the calculated earth-and-sand weight from being determined as the measurement result in a state where an error occurs in the torque around the boom base of the boom 4 due to entering into the cushion area. At this time, the earth-and-sand load processor 60 may display a notice on the display device 40 or the like, indicating that the measurement is performed again after lowering the boom 4.

In addition, in the present embodiment, when the state of the shovel 100 at the time when it is determined that the piston of the boom cylinder 7 has reached the cushion area is a state after the excavation and loading operation has started and the earth-and-sand weight has been determined, the already determined earth-and-sand weight is adopted as the measurement result and the determined earth-and-sand weight is not updated.

In other words, in the present embodiment, when the state of the work machine at the time when it is determined that the piston of the boom cylinder 7 has reached the cushion area is a state after the raising operation of the attachment has started and the measurement result of the weight of the object has been obtained, the already determined earth-and-sand weight is adopted as the measurement result and the determined earth-and-sand weight is not updated.

Therefore, according to the present embodiment, it is possible to prevent the earth-and-sand weight calculated in a state where an error occurs in the torque around the boom base of the boom 4 due to entering into the cushion area from being adopted as the measurement result, thereby enhancing the accuracy of the measurement of the earth-and-sand weight.

In addition, in the present embodiment, when the state of the shovel 100 at the time when it is determined that the piston of the boom cylinder 7 has reached the cushion area is a state in which the earth-and-sand weight has not been determined since the start of the excavation and loading operation, the earth-and-sand weight calculated by the load weight calculator 63 is adopted as the measurement result at the time when it is determined that the piston of the boom cylinder 7 has reached the cushion area to forcibly determine the earth-and-sand weight.

In other words, in the present embodiment, when the state of the work machine at the time when it is determined that the piston of the boom cylinder 7 has reached the cushion area is a state in which the raising operation of the attachment has started and the measurement result of the weight of the object has not been obtained, the earth-and-sand weight calculated by the load weight calculator 63 is adopted as the measurement result at the time when it is determined to forcibly determine the earth-and-sand weight.

Therefore, according to the present embodiment, a measurement area for measuring the earth-and-sand weight in a state in which the earth-and-sand weight is not affected by the piston of the boom cylinder 7 reaching the cushion area can be provided to a maximum extent.

Furthermore, in the present embodiment, when the piston of the boom cylinder 7 has reached the cushion area, the earth-and-sand weight not affected by the piston entering into the cushion area is taken as the measurement result, such that the earth-and-sand weight carried out by one cycle of the excavation and loading operation can be maintained to have a constant accuracy.

The accuracy of the measurement of the weight of an object can be enhanced.

In the present embodiment, the weight of the loaded object such as the earth and sand and scrap materials loaded onto the bed of the dump truck or a trailer can be measured with high accuracy, as described above, and the accuracy of calculating the remaining loadable amount can be enhanced. Therefore, according to the present embodiment, reworking and manual adjustment of the weighing can be reduced, and the work efficiency at the loading site can be enhanced. Furthermore, it can also contribute to the enhancement of the transportation efficiency and the suppression of the road damage caused by overloading.

What is claimed is:

1. A work machine, comprising:
a work machine body;
an attachment attached to the work machine body;
a work tool provided at a distal end of the attachment; and
control circuitry configured to, when a determination is made that a piston of a cylinder that operates the attachment has reached a predetermined range based on detection information related to a raising operation of the attachment after an object is held in the work tool, cause an obtaining measurement result of a weight of the object to differ according to a state of the work machine at a time when the determination is made.

2. The work machine according to claim 1, wherein
the control circuitry obtains the weight of the object calculated based on the detection information related to the raising operation of the attachment as the measurement result at the time the determination is made, when the state of the work machine at the time the determination is made is a state after the raising operation of the attachment has started and the measurement result of the weight of the object has not been obtained.

3. The work machine according to claim 1, wherein:
when the state of the work machine at the time the determination is made is a state after the raising operation of the attachment has started and the measurement result of the weight of the object has been obtained, the control circuitry obtains the measurement result that has been obtained as the measurement result of the weight of the object at the time the determination is made.

4. The work machine according to claim 1, wherein
the control circuitry determines whether or not the piston of the cylinder has reached the predetermined range based on a change amount of a cylinder pressure of the cylinder.

5. The work machine according to claim 1, wherein
the control circuitry does not obtain the measurement result when the state of the work machine at the time the determination is made is a state at start of the raising operation of the attachment.

6. The work machine according to claim 5, wherein
the control circuitry determines that the state of the work machine is in the state at the start of the raising operation of the attachment when a bottom pressure on a bottom side of the cylinder at the start of the raising operation of the attachment is equal to or greater than a predetermined value.

7. A work machine, comprising:
a work machine body;
an attachment attached to the work machine body;
a work tool provided at a distal end of the attachment; and
control circuitry configured to, when a determination is made that a piston of a cylinder that operates the attachment has reached a predetermined range based on detection information related to a raising operation of the attachment after an object is held in the work tool, cause an obtaining measurement result of a weight of the object to differ according to a state of the work machine at a time when the determination is made, wherein
the control circuitry
obtains the weight of the object calculated based on the detection information related to the raising operation of the attachment as the measurement result at the time the determination is made, when the state of the work machine at the time the determination is made is a state after the raising operation of the attachment has started and the measurement result of the weight of the object has not been obtained,
obtains the measurement result that has been obtained as the measurement result of the weight of the object at the time the determination is made when the state of the work machine at the time the determination is made is a state after the raising operation of the attachment has started and the measurement result of the weight of the object has been obtained, and
does not obtain the measurement result when the state of the work machine at the time the determination is made is a state at start of the raising operation of the attachment.

8. A control apparatus for a work machine, comprising:
a work machine body;
an attachment attached to the work machine body; and
a work tool provided at a distal end of the attachment, wherein
the control apparatus includes
control circuitry configured to, when a determination is made that a piston of a cylinder that operates the attachment has reached a predetermined range based on detection information related to a raising operation of the attachment after an object is held in the work tool, cause an obtaining measurement result of a weight of the object to differ according to a state of the work machine at a time when the determination is made.
